(19) United States
(12) Patent Application Publication
(10) Pub. No.: US 2025/0063976 A1
(43) Pub. Date: Feb. 27, 2025

(54) CROP YIELD MODELING BASED ON YIELD POTENTIAL

(71) Applicant: BASF CORPORATION, Florham Park, NJ (US)

(72) Inventors: Joseph Martin RUSSO, Bellefonte, PA (US); Jeffrey Wayne GRIMM, Durham, NC (US); Jay Wesley SCHLEGEL, Bellefonte, PA (US); Jeffrey Thomas SPENCER, Bellefonte, PA (US)

(21) Appl. No.: 18/724,964

(22) PCT Filed: Dec. 30, 2022
(86) PCT No.: PCT/US2022/054339

§ 371 Date: Jun. 27, 2024

Related U.S. Application Data
(60) Provisional application No. 63/295,546, filed on Dec. 31, 2021.

(51) Int. Cl. A01B 79/00; A01B 79/02

(52) U.S. Cl. CPC A01B 79/005; A01B 79/02

(57) ABSTRACT

Embodiments of the present disclosure related to systems and methods of determining, computing, or simulating crop yield for a growing season. In certain embodiments, the model begins with a yield potential reflective of environmental limitations for a particular field which assumes that the grower has chosen a crop variety that is appropriate for their growing season and has managed their farm optimally. An end-of-season yield is predicted by accounting for environmental stressors, which are applied to the starting yield potential as penalties, in certain embodiments, the crop yield model simulates post-, in-, and end-of-season yield potentials by classifying major categories of plant stressors. These stressors are used to track and penalize yield potential using a dynamic set of inputs. The crop yield model works in conjunction with a crop phenology model to facilitate identification of historical averages for various phenological states of the crop development.

### CROSS-REFERENCE TO RELATED APPLICATION(S)

This application claims the benefit of priority of U.S. Provisional Patent Application No. 63/295,546, filed on Dec. 31, 2021, the disclosure of which is hereby incorporated by reference herein in its entirety.

### TECHNICAL FIELD

The present disclosure relates to computational techniques for modeling crop yield.

### BACKGROUND

In agriculture it is desirable to maximize the production or yield of a given agricultural product. A number of techniques exist for simulating crop development and yield. Model accuracy can be compromised, however, when certain environmental stresses during a growing season are unaccounted for. Moreover, models often fail to account for variability in planting conditions as well as changes in underlying assumptions arising from evolving climate and weather patterns.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 illustrates an exemplary system architecture in accordance with embodiments of the present disclosure.

FIG. 2 is a block diagram illustrating an exemplary computer system in accordance with embodiments of the present disclosure.

FIG. 3 is a graphical depiction of a crop phenology model in accordance with embodiments of the present disclosure.

FIG. 4 is a flow diagram illustrating field-level crop phenology modeling in accordance with embodiments of the present disclosure.

FIG. 5 is a plot showing a relationship between 50% cohort corn planting date and winter climate index.

FIG. 6 is a flow diagram illustrating the inputs and outputs of various equations used in the field-level crop phenology model in accordance with embodiments of the present disclosure.

FIG. 7 is a flow diagram illustrating a method for simulating plant development stages in accordance with embodiments of the present disclosure.

FIG. 8 is a plot illustrating how yield potential is calculated starting with from genotypic potential.

FIG. 9 is a plot illustrating a relationship between air temperature and crown temperature as a function of snow depth.

FIG. 10 is a plot illustrating the distribution of the maximum clear sky radiation between the ideal planting and maturity dates.

FIG. 11 illustrates the impact on yield potential of planting delay.

FIG. 12 is a diagram illustrating soil-water balance.

FIG. 13 is a plot illustrating an exemplary crop coefficient curve.

FIG. 14 shows minimum survival temperatures for winter wheat varieties that have low, mid, and high hardiness.

FIG. 15 is a flow diagram illustrating a method for simulating crop yield for a growing season in accordance with embodiments of the present disclosure.

### DETAILED DESCRIPTION

Described herein are embodiments of a crop yield model for simulating crop yield potential. In certain embodiments, the model begins with a yield potential reflective of environmental limitations for a particular field which assumes that the grower has chosen a crop variety that is appropriate for their growing season and has managed their farm optimally. An end-of-season yield is predicted by accounting for environmental stressors, which are applied to the starting yield potential as penalties. In certain embodiments, the crop yield model simulates post-, in-, and end-of-season yield potentials by classifying major categories of plant stressors. These stressors are used to track and penalize yield potential using a dynamic set of inputs (e.g., weather, soil, and farmer management activities). The crop yield model works in conjunction with a crop phenology model to facilitate identification of historical averages for various phenological states of the crop development. The embodiments herein advantageously allow farmers to better estimate their post-, in-, and end-of-season yield potentials, and provide the ability to develop new digital business models and establishing risk/reward thresholds for grower field activities.

Particularly, crop yield may be considered to be the harvested biomass from a seeded plant population in an agricultural field measured in units of mass per area, e.g., in units of kilograms per hectare, or pounds per acre.

Discussed below in greater detail are the phenology model that describes plant development, and the crop yield model which utilizes the crop phenology model.

The term “agent” or the like as used in the context of the present disclosure refer to any substance, material or microorganism usable for treating a crop, including but not limited to herbicide, fungicide, insecticide, acaricide, molluscicide, nematicide, rodenticide, repellant, bactericide, biocide, safener, adjuvant, plant growth regulator, fertilizer, urease inhibitor, nitrification inhibitor, denitrification inhibitor, bioherbicide, biofungicide, bioinsecticide, bioacaricide, biomolluscicide, bionematicide, biorodenticide, biorepellant, biobactericide, biological biocide, biological safener, biological adjuvant, biological plant growth regulator, biological urease inhibitor, biological nitrification inhibitor, or biological denitrification inhibitor, or any combination thereof.

### General System Embodiments

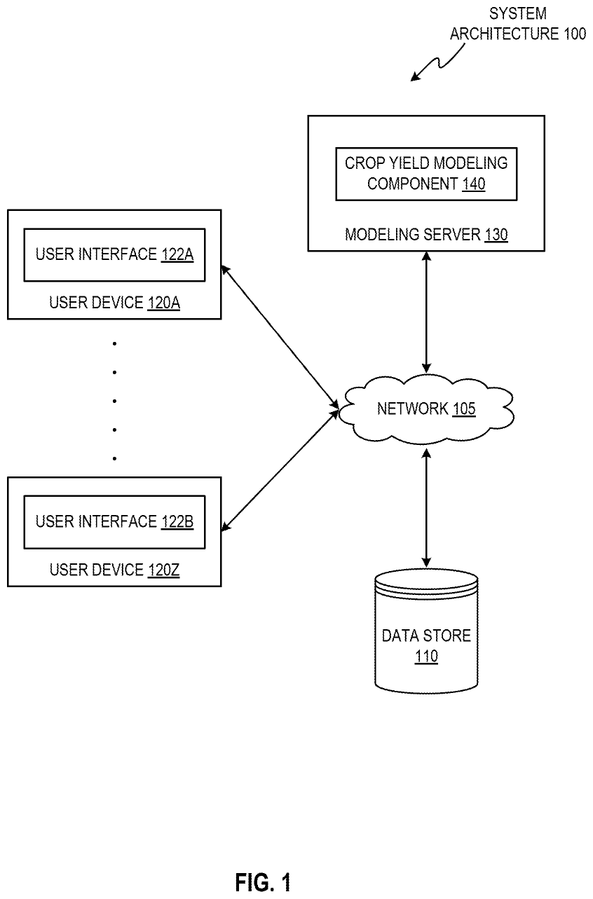

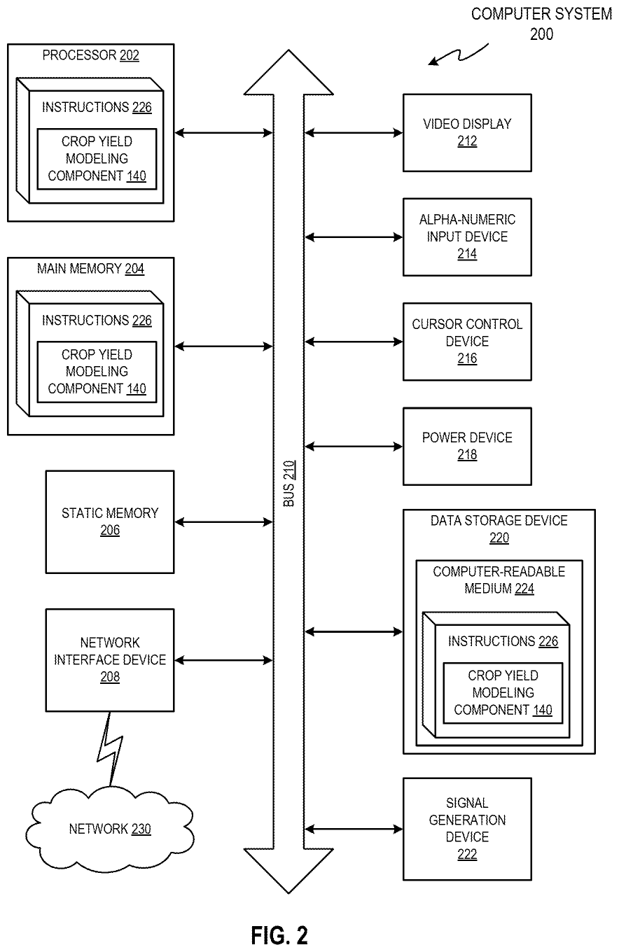

Exemplary implementations of the embodiments described herein are now described. FIG. 1 illustrates an exemplary system architecture 100, in accordance with embodiments of the present disclosure. The system architecture 100 includes a data store 110, user devices 120A-120Z, and a modeling server 130, with each device of the system architecture 100 being communicatively coupled via a network 105. One or more of the devices of the system architecture 100 may be implemented using a generalized computer system 200, described below with respect to FIG. 2. The devices of the system architecture 100 are merely illustrative, and it is to be understood that additional data stores, user devices, modeling servers, and networks may be present.

In one embodiment, network 105 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. Although the network 105 is depicted as a single network, the network 105 may include one or more networks operating as stand-alone networks or in cooperation with each other. The network 105 may utilize one or more protocols of one or more devices to which they are communicatively coupled. The network 105 may translate to or from other protocols to one or more protocols of network devices.

In one embodiment, the data store 110 may include one or more of a short-term memory (e.g., random access memory), a cache, a drive (e.g., a hard drive), a flash drive, a database system, or another type of component or device capable of storing data. The data store 110 may also include multiple storage components (e.g., multiple drives or multiple databases) that may also span multiple computing devices (e.g., multiple server computers). In certain embodiments, the data store 110 may be cloud-based. One or more of the devices of system architecture 100 may utilize their own storage and/or the data store 110 to store public and private data, and the data store 110 may be configured to provide secure storage for private data. In certain embodiments, the data store 110 may be used for data back-up or archival purposes.

The user devices 120A-120Z may include a computing device such as a personal computer (PC), laptop, mobile phone, smart phone, tablet computer, netbook computer, etc. User devices 120A-120Z may also be referred to as a “client device” or “mobile device.” An individual user may be associated with (e.g., own and/or operate) one or more of the user devices 120A-120Z. One or more of the user devices 120A-120Z may also be owned and utilized by different users at different locations. As used herein, a “user” may be represented as a single individual. However, other embodiments of the present disclosure encompass a “user” being an entity controlled by a set of users and/or an automated source. For example, a set of individual users federated as a community in a company or government organization may be considered a “user.”

The user devices 120A-120Z may each utilize one or more local data stores, which may be internal or external devices, and may each include one or more of a short-term memory (e.g., random access memory), a cache, a drive (e.g., a hard drive), a flash drive, a database system, or another type of component or device capable of storing data. The local data stores may also include multiple storage components (e.g., multiple drives or multiple databases) that may also span multiple computing devices (e.g., multiple server computers). In certain embodiments, the local data stores may be used for data back-up or archival purposes.

The user devices 120A-120Z may implement user interfaces 122A-122Z, respectively, which may allow each respective user device to send/receive information to/from other user devices, the data store 110, and the modeling server 130. Each of the user interfaces 122A-122Z may be a graphical user interface (GUI). For example, the user interface 122A may be a web browser interface that can access, retrieve, present, and/or navigate content (e.g., web pages such as Hyper Text Markup Language (HTML) pages) provided by the modeling server 130. In one embodiment, the user interface 122A may be a standalone application (e.g., a mobile “app,” etc.), that enables a user to use the user device 120A to send/receive information to/from other user devices, the data store 110, and the modeling server 130.

In one embodiment, the modeling server 130 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components from which digital contents may be retrieved. In certain embodiments, the modeling server 130 may be a server utilized by any of the user device 120 to retrieve/access content or information pertaining to content. In certain embodiments, additional modeling servers may be present.

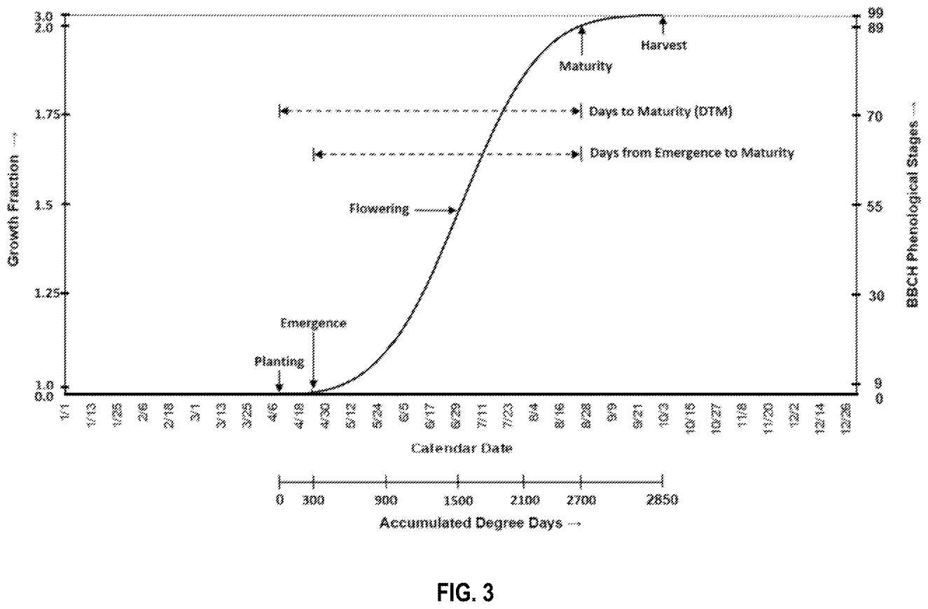

In certain embodiments, the modeling server 130 may implement a crop yield modeling component 140 to simulate crop yield potential. The functionality of the crop yield modeling component 140 is described in greater detail below with respect to FIGS. 3-15.

Although each of the data store 110, the user devices 120A-120Z, and the modeling server 130 are depicted in FIG. 1 as single, disparate components, these components may be implemented together in a single device or networked in various combinations of multiple different devices that operate together. In certain embodiments, some or all of the functionality of the modeling server 130 may be performed by one or more of the user devices 120A-120Z, or other devices that are under control of the modeling server 130.

FIG. 2 illustrates a diagrammatic representation of a machine in the exemplary form of a computer system 200 within which a set of instructions (e.g., for causing the machine to perform any one or more of the methodologies discussed herein) may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 200 may be utilized by or illustrative of any of the devices of the system architecture 100, such as the data store 110, one or more of the user devices 120A-120Z, and the modeling server 130.

The exemplary computer system 200 includes a processing device (processor) 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 220, which communicate with each other via a bus 210.

Processor 202 represents one or more general-purpose processing devices such as a microprocessor, central processing unit, or the like. More particularly, the processor 202 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 202 may also be one or more special-purpose processing devices such as an ASIC, a field programmable gate array (FPGA), a digital signal processor (DSP), network processor, or the like. The processor 202 is configured to execute instructions 226 for performing the operations and steps discussed herein.

The computer system 200 may further include a network interface device 208. The computer system 200 also may include a video display unit 212 (e.g., a liquid crystal display (LCD), a cathode ray tube (CRT), or a touch screen), an alphanumeric input device 214 (e.g., a keyboard), a cursor control device 216 (e.g., a mouse), and a signal generation device 222 (e.g., a speaker).

Power device 218 may monitor a power level of a battery used to power the computer system 200 or one or more of its components. The power device 218 may provide one or more interfaces to provide an indication of a power level, a time window remaining prior to shutdown of computer system 200 or one or more of its components, a power consumption rate, an indicator of whether computer system is utilizing an external power source or battery power, and other power related information. In certain embodiments, indications related to the power device 218 may be accessible remotely (e.g., accessible to a remote back-up management module via a network connection). In certain embodiments, a battery utilized by the power device 218 may be an uninterruptable power supply (UPS) local to or remote from computer system 200. In such embodiments, the power device 218 may provide information about a power level of the UPS.

The data storage device 220 may include a computer-readable storage medium 224 on which is stored one or more sets of instructions 226 (e.g., software) embodying any one or more of the methodologies or functions described herein. The instructions 226 may also reside, completely or at least partially, within the main memory 204 and/or within the processor 202 during execution thereof by the computer system 200, the main memory 204 and the processor 202 also constituting computer-readable storage media. The instructions 226 may further be transmitted or received over a network 230 (e.g., the network 105) via the network interface device 208.

In one embodiment, the instructions 226 include instructions for the crop yield modeling component 140, as described with respect to FIG. 1 and throughout this disclosure. For example, the crop yield modeling component 140 may be implemented by the modeling server 130 or the user devices 120A-120Z. While the computer-readable storage medium 224 is shown in an exemplary embodiment to be a single medium, the terms “computer-readable storage medium” or “machine-readable storage medium” should be taken to include a single medium or multiple media (e.g., a centralized or distributed database, and/or associated caches and servers) that store the one or more sets of instructions. The terms “computer-readable storage medium” or “machine-readable storage medium” shall also be taken to include any transitory or non-transitory medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

### Phenology Model

The field-scale crop phenology model (also referred to herein as the “crop phenology model” or “phenology model”) is used to simulate plant development stages during a growing season. Knowledge of plant stages, especially as a forecast, helps the timing of chemical applications as well as other crop development-dependent management decisions. Together with a user's field location, planting date, and varietal information (i.e., one or more crop types), the crop phenology model serves as a robust field-scale decision-making tool. In certain embodiments, the phenology model can be run under three different scenarios: historical, preseason, or in-season. Using a blend of different weather data inputs (historical, forecasted, long-range forecasted, and climatology), the phenology model can generate phenology results based on the desired scenario of a user.

Certain embodiments of the phenology model utilize temperature rather than days after planting to simulate plant development and growth during a growing season. A plant has thermal requirements in order to perform its daily physiological processes. These requirements can be defined by air temperature. A plant can survive and function between upper and lower air temperature limits with its optimal growth somewhere between these limits. For each type of crop, there is specific base air temperature above which measurable biomass accumulation is observed during a growing season. Daily average air temperatures are subtracted from this base as a measure of the heat for plant development and growth. The result of this subtraction is referred to as “growing degree days” or “growing degree units.” Daily growing degree days are accumulated over a growing season to track crop development and growth.

In certain embodiments, the phenology model uses climatically-derived accumulated degree days between the planting and harvest stages. Crop growth prior to emergence, however, is a function of soil temperature rather than air temperature. Therefore, the embodiments described herein utilize one or more universal equations with crop type-specific coefficients, which uses soil temperature at seeding depth to better simulate crop germination and emergence. Use of a soil temperature emergence function allows for a more accurate simulation for a given growing season as compared to a degree day accumulation approach alone.

In certain embodiments, adjustments are made to the degree days between both emergence and flowering and flowering and maturity. An adjustment between emergence and flowering to accumulated degree days accounts for influences of photoperiod and daylength on crop development. This adjustment is particularly important for types of crops that experience dormancy during winter months. An adjustment between flowering and maturity to accumulated degree days accounts for equifinality. As used herein, “equifinality” refers to the speeding up (less degree days) of the seed-fill period due to a significant delay in a crop's development by the flowering stage. The derivation of growing degree days and their adjustments are discussed in detail below. Utilization of the photoperiod and equifinality adjustments allows for more realistic simulations of the physiological processes associated with plant development.

Certain embodiments utilize a climatological framework. In many countries, there is little or no data on crop varieties and their development characteristics. Therefore, the embodiments herein contemplate a framework that utilizes historical observations of crop growth stages and climatological air temperature records. The framework results in universal functions with crop type-specific coefficients for calculating the dates of key phenological stages based on climatological indices. This allows the degree day requirements for days to maturity to be climatologically determined anywhere in the world. The climatological framework provides an important reference to evaluate the validity of user-provided varietal days to maturity and further allows a determination as to whether a crop is achieving optimal development for a growing season.

The assignment of phenological stages to accumulated degree days is achieved indirectly with a crop growth fraction. The crop growth fraction is calculated by dividing accumulated degree days by the total number of degree days between stages, as is discussed in greater detail below. The crop growth fraction, through its normalization of accumulated degree days to total degree days to maturity, alleviates the need to associate crop phenology schemes (e.g., the BBCH phenological scheme) to growing degree days.

### 1. Phenology Model Overview

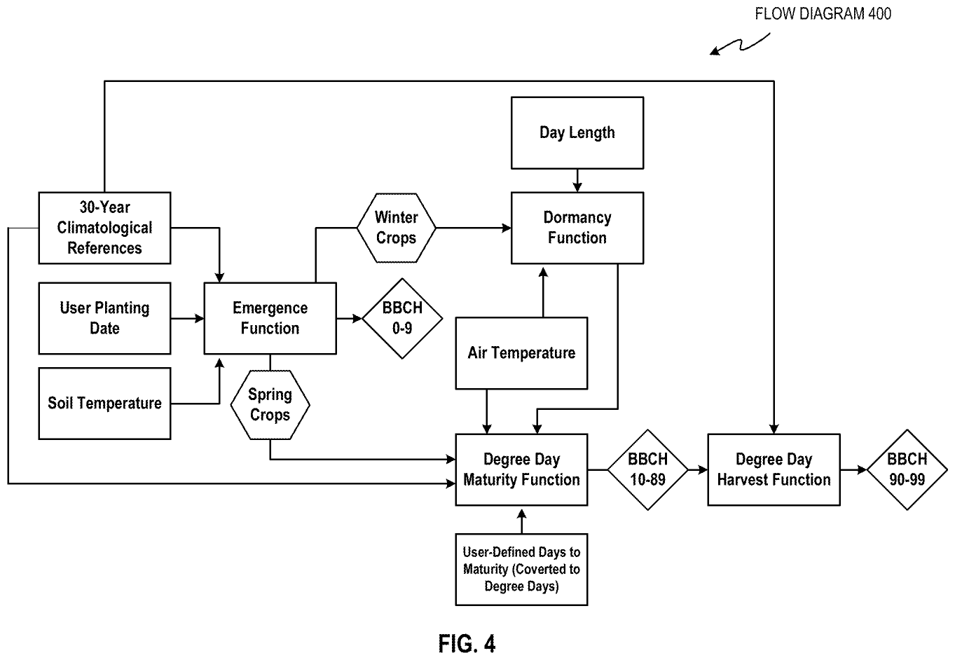

In certain embodiments, the phenology model is a physical deterministic model that dynamically simulates phenological stages of plant growth. The model functions with a series of universal equations that are parameterized by crop type, allowing the model to be quickly scaled by both crop and growing region. In certain embodiments, the model first calculates crop growth fractions. The calculation of crop growth fractions is a unique approach that allows for flexibility in tailoring to different phenological schemes. The period between planting and emergence utilizes a soil temperature model to calculate growth fraction, whereas the period between emergence and maturity utilizes accumulated degree days. Growth fraction, accumulated degree days, and the mapping to the BBCH phenological scheme are discussed in more detail with respect to FIG. 3. FIG. 4 is a flow diagram illustrating a high-level overview of the crop phenology model in accordance with embodiments of the present disclosure.

In certain embodiments, crop growth fraction (CGF) is defined to range from 0.0 to 3.0, and crop growth is divided into three periods: planting to crop emergence (0-1.0), emergence to maturity (1.0-2.0), and maturity to harvest (2.0-3.0). During the period between planting and crop emergence, the crop growth fraction depends on a function tracking the five-day running average of soil temperature at seeding depth. The soil temperature model provides the total numbers of days between planting and emergence. The growth fraction during this period is then determined by using a formula that divides the current number of days from the planting date by the total number of days to reach emergence. In certain embodiments, this fraction dynamically changes as the weather conditions and soil temperature change until the date of emergence is reached.

In certain embodiments, the growth fraction between emergence and maturity is first calculated using the daily seasonal accumulated degree days divided by climatologically-derived total accumulated degree days between the phenological stages defining the period. The crop growth fraction for the period between emergence and maturity is then incrementally increased from 1.0 to 2.0.

An example is now described to demonstrate growth fraction. Based on the data illustrated in FIG. 3, the number of accumulated degree days required between emergence and maturity is 2400 (2700 minus the accumulation between planting and emergence of 300, in this example). Each day of the growing season, the daily degree days are calculated and accumulated. If on the first day following emergence, there are 10 degree days, the growth fraction would be 1.0+10/2400, or 1.0042 (noting that that growth fraction increases from 1.0 to 2.0 between emergence and maturity). If 15 degree days occur the following day, the growth fraction is now 1+25/2400, or 1.0104.

In a similar fashion, the crop growth fraction for the period between maturity and harvest may be calculated using the daily seasonal accumulated degree days divided by the climatologically-derived total accumulated degree days between the phenological stages defining the period. The crop growth fraction for the period between maturity and harvest then incrementally increases from 2.0 to 3.0.

Finally, the phenological stages, as enumerated by BBCH codes for example, are associated with the crop growth fractions. The translation (or mapping) between growth fraction and BBCH is both crop- and region-dependent. An example of mapping BBCH codes to corn growth fractions may be as follows:
BBCH 0 to fraction 0 at planting
BBCH 5 to fraction 0.5 at germination
BBCH 9 to fraction 1.0 at emergence
BBCH 11 to fraction 1.02 at first leaf
BBCH 19 to fraction 1.24 at 9 leaves
BBCH 65 to fraction 1.55 at fully-emerged stigmata
BBCH 73 to fraction 1.66 at early milk
BBCH 89 to fraction 2.0 at black layer (maturity)
BBCH 99 to fraction 3.0 at harvest

While BBCH was chosen as the default crop phenology scale, other phenology scales (e.g., ISU scale) can be easily mapped to the growth fraction as would be understood and appreciated by one of ordinary skill in the art.

FIG. 3 further illustrates the concept of days to maturity (DTM). As used herein, DTM can be defined as the amount of time, in days, that a crop needs to reach maturity from the date of planting, and it indicates the point where the total accumulated degree days between planting and maturity, for a climatically normal season, reaches a variety-specific threshold for maturity. DTM varies as a function of crop type, variety, and growing region, and DTM is typically reported by seed manufacturers. If not reported, DTM can also be derived from historical observations. Utilizing the correct DTM is important for accurate simulation of phenological stages because a DTM determines the accumulated degree day requirements of a crop variety. An incorrect or inaccurate DTM can result in the model simulating crop development too quickly or too slowly, complicating the timing of an application or the planning of other stage-specific field activities during a growing season.

### 2. Climatological Calculations

In certain embodiments, the crop phenology model can be quickly scaled by both crop type and growing region, which can be attributed to underlying climatological backbone. By combining large-scale geographic datasets, relationships can be developed between many years of crop-specific records of planting, emergence, maturity, and harvest and weather data for the same years and scales. An example of such a dataset is the crop statistics dataset provided by the National Agricultural Statistics Service (NASS), within the United States Department of Agriculture. Annual observations of planting, emergence, maturity, and harvest dates for a given crop are published for each state of the United States. They are presented as a range or distribution of dates centered on the most active or “average” dates. The average dates are referred to herein as “50% cohort” dates to acknowledge their position in their respective distributions of actual planting dates. The average dates are used to develop the relationships with weather data. Deutscher Wetterdienst (DWD) provides similar statistics for Germany. It is noted that these climatological calculations are valid for latitudes above 24° north and south of the equator; a different climatological approach is used for the tropics in certain embodiments.

### 2.1 Annual Ratio, Winter Climate Index, and Generic 50% Cohort Function

The relationship between crop phenology and weather data may be defined in two steps. First, two climate indices are developed from historical minimum and maximum air temperature data. These indices may be used to define gradients in climatological environments around the world. The two indices are referred to herein as the “annual ratio” and the “winter climate index.” Using the period between January 1 and December 31, the annual ratio (RATIO) may be calculated as the climatological warmest daily air temperature (TMPXH) in ° C. minus the climatological coldest daily air temperature (TMPNH) in ° C. divided by climatological warmest daily air temperature (TMPXH) in ° C. In certain embodiments, the climatological warmest air temperature and coldest air temperature are derived by harmonically-fitting 30 years of daily maximum and minimum air temperature data, respectively. The annual ratio (RATIO) equation is defined as follows:

$$RATIO = ( TMPXH - TMPNH ) / TMPXH , °C . \qquad Eq . 1$$

Using the period between October 1 and March 31 in the northern hemisphere, the winter climate index (WCI) may be calculated as the climatological winter daily maximum air temperature (WTMPXH) in ° C. minus the climatological winter daily minimum air temperature (WTMPNH) in ° C. divided by the climatological winter daily maximum air temperature (WTMPXH) in ° C. The climatological winter daily maximum and minimum air temperatures are derived by harmonically-fitting 30 years of daily winter maximum and minimum air temperature data, respectively. For the southern hemisphere, the date range for WCI calculation is April 1 to September 30. The winter climate index (WCI) is defined as follows:

$$W C I = ( WTMPXH - WTMPNH ) / WTMPXH , °C . \qquad Eq . 2$$

The second step for deriving the relationship between crop phenology data and weather data is to create a function relating the average dates of each observed crop-specific, phenological stage and one of the climate indices. The resulting function is used to determine the date that a crop-specific phenological stage (PSDATE50%) would appear for 50% of fields in each climatological environment defined by one of the indices. In certain embodiments, values for the coefficients (PSDATEA, PSDATEB, PSDATEC, PSDATED) in the function are unique for each crop and phenological stage.

In certain embodiments that utilize the annual ratio (RATIO):

$$PSDATE 50 \% = PSDATEA - PSDATEB / ( 1. + EXP ( PSDATEC * ( PSDATED - RATIO ) ) ) , DOY ; \qquad Eq . 3$$

in certain embodiments that utilize the winter crop index (WCI):

$$PSDATE 50 \% = PSDATEA - PSDATEB / ( 1. + EXP ( PSDATEC * ( PSDATED - W C I ) ) ) , DOY , \qquad Eq . 4$$

where:
PSDATE50% is the average or 50% cohort date of a stage,
PSDATEA is the latest planting date for a stage,
PSDATEB is the difference between latest and earliest planting dates for a stage,
PSDATEC is a unitless scalar determining the slope of the curve for a stage, and
PSDATED is the unitless minimum value for RATIO or WCI.

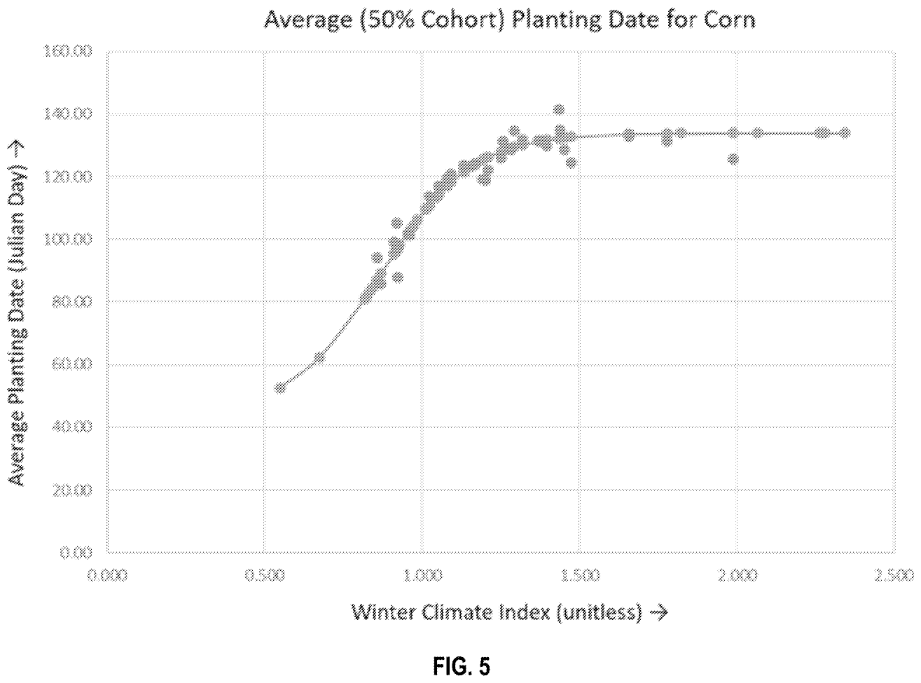

An example of a curve derived from this function is depicted in FIG. 5, which shows a relationship between average or 50% cohort planting date for corn and WCI (the function is depicted as a solid line and observed phenological data is depicted by dots). In certain embodiments, the equations relating the average or 50% cohort date and the RATIO and WCI are the same for all crops types, with the coefficients varying for each crop type.

### 2.2 50% Cohort Planting Date

The following equations calculates day of year (DOY) for the 50% cohort planting date (PLDATE50%) as a function of either RATIO or WCI.

In certain embodiments that utilize RATIO:

$$PLDATE 50 \% = PLDATEA - PLDATEB / ( 1. + EXP ( PSDATEC * ( PSDATED - RATIO ) ) ) , DOY ; \qquad Eq . 5$$

in certain embodiments that utilize WCI:

$$PLDATE 50 \% = PLDATEA - PLDATEB / ( 1. + EXP ( PLDATEC * ( PLDATED - W C I ) ) ) , DOY , \qquad Eq . 6$$

where,
PLDATEA is the latest planting date,
PLDATEB is the difference between latest and earliest planting dates,
PLDATEC is a unitless scalar determining the slope of the curve, and
PLDATED is the unitless minimum value for RATIO or WCI.

The aforementioned parameters, PLDATEA, PLDATEB, PLDATEC, and PLDATED can differ from crop to crop.

### 3. User-Specific Field-Scale Calculations

In certain embodiments, the climatological functions described above play a variety of roles when the crop phenology model is run at different spatial scales and in cases where knowledge of varietal characteristics or planting practices is limited. The role of climatological functions is now discussed for embodiments of a field-scale phenology model for which a full description about a crop variety and planting date is provided.

### 3.1 Terminology

In certain embodiments, to run the crop phenology model at the field-scale, a user (e.g. grower) provides, at the minimum, information about the choice of crop species and variety and planting date(s). A selected variety will have genetically-expressed, physiological characteristics (e.g., maturity rating, disease resistance, standability, drought tolerance, etc.) that may or may not be reported by a seed manufacturer. One such characteristic important for phenological modeling is the days to maturity (DTM), which is the number of days required for a crop to reach maturity after planting. DTM is a measure of the length of a growing season. As such, it is derived in certain embodiments with the assumption that a user will plant a crop in a range of days centered on a typical or average date (as determined from historical planting practices) for a given geographic region.

Since a crop will develop according to seasonal weather conditions and not by calendar days, in certain embodiments DTM is converted into an environmental measure, such as degree days. Adding or accumulating degree days over the period defined by the days to maturity can be interpreted as a measure of the heat available to a crop over a growing season.

Assuming a planting date is known, accumulated degree days for a specific DTM can be derived in certain embodiments from historical weather data. Accumulated degree days can correspond to the addition of daily climatological degree days between the planting date and maturity date as defined by the DTM. The climatological degree days can be derived from the preceding ten years of historical air temperature records. Since calendar dates for the beginning and end of a DTM will change with different user planting dates, the required accumulated degree days over the same number of days may also change. For the same DTM, the number of degree days accumulated from a specific user planting date may differ from the number of degree days accumulated from an average planting date based on historical practices. In other words, a user planting date may differ from the planting dates in the research trials a seed manufacturer conducted to define the DTM for a given variety. Choosing the right variety and planting date is important for maximizing yield potential for a growing season at a location. Planting too early or too late may result in a mismatch to the genetically-expressed environmental requirements of a variety and a reduction in yield potential.

Even if a DTM of a variety is correct for a user's geographic location and planting date, there would potentially be a difference in the simulated and observed dates of a phenological stage during a growing season. Variables other than air temperature can affect development. Management decisions, such as row and plant spacing, seed depth, and the application of growth regulators, can contribute to differences in the seasonal progression of crop phenological stages. Furthermore, since plant development within a field is typically uneven (i.e., different stages occurring on the same date), observational protocol plays a large role in determining a representative stage for an entire field. To account for deviations in the output of the phenology model due to these various factors, certain embodiments may utilize a “biofix” factor to account for potentially significant deviations between simulation and observation. The biofix factor may be a user-entered observation that replaces a simulated phenological stage. In such embodiments, the crop phenology model can ingest a user-entered stage and perform a real-time calibration of the required degree days up to and after the date of an observation. The end result of a calibration is more accurate simulated stages during the remainder of a growing season.

As discussed above, crop growth fraction is defined in certain embodiments to correspond to three periods: planting to emergence (0-1.0), emergence to maturity (1.0-2.0), and maturity to harvest (2.0-3.0). The first period tracks underground plant growth including seed germination, root growth, and up to the emergence of first leaves at the surface. The second period marks both underground root expansion and aboveground plant growth including extending stems and increased foliage, flowering, and fruit set and enlargement. The third period is characterized by a dying plant with drying and falling leaves aboveground and a thinning and shrinking root system underground. Crop development in the first period is primarily a function of heat (soil temperature) and soil moisture (available water in rooting depth). Crop development in the second period is primarily a function of light (incoming solar radiation), heat (air temperature), and soil moisture (available water in rooting depth). Crop development in the third period is a function of heat (air temperature) and canopy moisture (wetting due to precipitation).

Crop development and growth are impacted differentially by below ground and above ground environments during a growing season. Accordingly, in certain embodiments, the simulation of phenological stages utilizes different approaches for each of the three growth fraction periods. In certain embodiments, the first period phenological stages (planting to emergence) are simulated with soil temperature. In certain embodiments, the second period stages (emergence to maturity) are simulated with accumulated degree days. In certain embodiments, the required degree-day accumulation for the second period is the first period degree-day total between planting and emergence subtracted from degree-day total for a DTM between planting and maturity. In certain embodiments, the third period stages (maturity to harvest) are simulated with accumulated degree days derived from historical practices and weather data.

The accumulated degree days in the first period can be estimated using two approaches. In certain embodiments, the first approach utilizes the climatological functions described above. A degree-day accumulation can be calculated for the days between the climatologically-determined 50% cohort planting and emergence dates. The climatological planting to emergence degree days can be subtracted from planting to maturity degree days for a DTM to derive the degree-day accumulation between emergence and maturity (also referred to as the DDMAT).

In certain embodiments, the second approach is to first utilize a user-inputted planting date and run a function based on soil temperature to calculate an emergence date. Next, degree days are calculated between the user-inputted planting date and the calculated emergence date using air temperature data from each of ten historical years (noting that the number of years may vary in different embodiments). Finally, average the calculated degree days between the user planting date and the calculated emergence date over all ten years. Similar to the first approach, the ten-year, average degree-day accumulation between planting and emergence would be subtracted from a planting to maturity degree days for a DTM to derive the DDMAT or degree-day accumulation between emergence and maturity. It is noted that this second approach assumes that the user planting date is within the range of days around the average date used to define a variety's DTM. If a user's planting date is out of range, then the DDMAT could be incorrect resulting in an error in the simulation of phenological dates during a growing season.

### 3.2 User Crop Emergence Date

In certain embodiments, the user emergence date (UEMDATE) is determined by seasonal soil conditions after the user planting date (UPLDATE). The number of days to emergence may be determined by soil temperature at seeding depth and may be calculated with an emergence (EM) function. In certain embodiments, crop emergence refers to the number of days between planting and when the first leaves break through a soil surface. The crop emergence depends on, for example, a five-day running average of soil temperature (5dST) at seeding depth. The emergence (EM) equation defines the required number of days for emergence based on weather conditions in a current season. The required number of days for emergence will vary year-to-year between a minimum (Min) and maximum (Max) number of days, which will be a function of the following parameters: minimum number of days to emergence; the difference between the minimum and maximum number of days to emergence; a unitless scalar determining the shape of the sigmoid curve; the soil temperature at planting depth; the reference soil temperature corresponding to the maximum number of days to emergence; and a factor to normalize the difference between observed and reference soil temperatures.

Since the five-day running average of soil temperature will change with each successive day after planting, the required number of days for emergence may be dynamically calculated in certain embodiments. A series of days having warmer soil temperatures will reduce the number of days to emergence, while a series of colder soil temperatures will increase the number of days. In certain embodiments, the required number of days to emergence is dynamically calculated every day along with an accumulated number of days from planting. Emergence may be considered to occur on the date when then the post-planting accumulated number of days exceeds or equals the required days determined from the soil temperature emergence (EM) function.

As an example to illustrate the dynamic calculation of days to emergence, suppose that the five-day running average of soil temperature at seeding depth is cold one day after planting. The cold soil temperature results in a calculation of 15 days to emergence. On the fourth day after planting (an accumulation of 4 days), the soil warms and the new calculation for days to emergence is 12 days. On the eighth day after planting (an accumulation 8 days), the soil continues to warm, and the new calculation is 10 days. Over the next two days, there is no further warming in the soil. The accumulated days from planting reaches 10, which matches the required number of days for emergence, and therefore emergence occurs on that date (UEMDATE).

Because the emergence date may be dynamically calculated after planting, the crop growth fraction may also be derived dynamically. In certain embodiments, the crop growth fraction ranges between 0 and 1.0 for the period between planting and emergence and may be calculated as the accumulated days after planting divided by the simulated required number of days for emergence. Since the required number of days will likely change day-to-day, the crop growth fraction will likely change in a non-linear fashion in successive days after planting.

As an example to illustrate the dynamic nature of the crop growth fraction between planting and emergence, the same progression of accumulated days after planting and calculations for days to emergence in the preceding example will be used. The calculation of crop growth fraction is set to 0 on the planting date. With the required days to emergence calculated to be 15 on the first day after planting, the growth fraction is 1/15 or 0.07. With the required days calculated to be 12 on the fourth day after planting, the growth fraction is 4/12 or 0.33. With the required days calculated to be 10 on the eighth day after planting, the growth fraction is 8/10 or 0.8. With the required days calculated to be 10 on the tenth day after planting, the growth fraction is 10/10 or 1.0, indicating the occurrence of emergence. The date of emergence is ten days after the planting date. Table 1 further illustrates this concept.

TABLE 1
Illustrative example of the dynamic nature of the soil
temperature emergence function and growth function

| | Soil | | | |
|---|---|---|---|---|
| | Temperature | EM | GF | Growth Stage |
| Day | (descriptive) | (days) | (unitless) | (BBCH) |
| 0 (UPLDATE) | Cold | 15 | 0.00 | 0 - Planting |
| 1 | Cold | 15 | 0.07 | — |
| 2 | Cold | 15 | 0.13 | — |
| 3 | Cold | 15 | 0.20 | — |
| 4 | Warmer | 12 | 0.33 | — |
| 5 | Warmer | 12 | 0.42 | — |
| 6 | Warmer | 12 | 0.50 | - Germination |
| 7 | Warmer | 12 | 0.58 | — |
| 8 | Warmer | 10 | 0.80 | — |
| 9 | Warmer | 10 | 0.90 | — |
| 10 (UEMDATE) | Warmer | 10 | 1.00 | 9 - Emergence |

### 3.3 User Crop Maturity Date (Spring Crops)

In certain embodiments, the crop maturity date for spring or winter crops is determined for a given season by adding daily degree days after emergence until the date the accumulation equals or exceeds the varietal requirement defined by the DDMAT. The DDMAT for winter crops may be complicated by a slowdown of growth over the winter months. The adjustment of the DDMAT winter slow growth or “dormancy” will be discussed in greater detail below.

In the case of both spring and winter crops, a user is rarely aware of the DDMAT of a variety since a seed manufacturer typically only publishes the DTM to define the length of a season (planting to maturity) and the emergence date varies significantly year-to-year due to the soil environment. Accordingly, the DDMAT is derived, in certain embodiments, from either historical planting practices or a user reported planting date. Since a user's planting date may be outside the range of dates that were used to determine the DTM from research studies, the historical practices may be chosen as the best approach.

In certain embodiments, the derivation of a user's crop maturity date (UMATDATE) involves three calculations. The first calculation is the accumulated degree days for a user-reported DTM (UDTM). This calculation can be performed after establishing dates for the beginning (planting date) and end (maturity date) of the UDTM. Using the climatological approach, the beginning date is the 50% planting date (PLDATE50%) and the ending date is the date after adding the DTM's days to maturity to the planting date (CMATDATE). The UDTM accumulated degree days then correspond to the addition of climatological daily degree days between the beginning date (PLDATE50%) and the ending date (CMATDATE):

$$UDTM = \sum degree days between CMATDATE and PLDATE 50 \% , degree days . \qquad Eq . 7$$

The second calculation determines the accumulated degree days for the UDDMAT or days form emergence to maturity for the reported user variety. The UDDMAT accumulated degree days is calculated by subtracting accumulated degree days between the climatological planting date (PLDATE50%) and emergence date (EMDATE50%) from the UDTM accumulated degree days:

$$UDDMAT = UDTM - \sum degree days between EMDATE 50 \% and PLDATE 50 \% , degree days . \qquad Eq . 8$$

The UDDMAT represents the required accumulated degree days between emergence and maturity based on a user-reported DTM and the assumption that the variety's planting date followed historical practices.

The third and last calculation for deriving the user maturity date (UMATDATE) is adding to the user emergence date (UEMDATE) the UDDMAT in equivalent days for the period defined by the accumulated degree days:

$$UMATDATE = UEMDATE + UDDMAT ( days ) , DOY . \qquad Eq . 9$$

With the calculation of the user maturity date (UMATDATE), the crop phenology model can provide field scale simulations of phenological stages for any user planting date and DTM in any geography. It is noted that the calculations discussed above apply to spring crops; winter crop development is complicated by dormancy during the winter months and is discussed in greater detail below.

In certain embodiments, daily growth fraction is calculated between emergence date and harvest date by calculating the daily degree day accumulation divided by the UDDMAT. The accumulation of the growth fraction begins at 1.0 (UEMDATE) and ends at 2.0 (UMATDATE). The accumulated growth fraction (AGF) is then mapped to the relevant crop phenology scale (e.g., 9 to 89 for the BBCH scale).

### 3.4 User Crop Maturity Date (Winter Crops)

In certain embodiments, the derivation of the user crop maturity date (UMATDATE) for winter crops is similar to spring crops except for a wintertime period of slowed growth. In higher latitudes, crop development slows during the colder winter months due to both lower temperatures and to reduced daylight. This period of slow growth is referred to herein as “dormancy,” and its length is determined by crop's sensitivity to photoperiod and daylength. In certain embodiments, the crop phenology model accounts for photoperiod sensitivity (R_{P}) and daylength (L_{P}) using a dormancy (DORM) function defined as follows:

$$DORM = 1 - 0.002 * {R}_{P} * {( 20 - {L}_{P} )}^{2} , unitless , \qquad Eq . 10$$

where,
DORM is a unitless scalar,
0.0002 is a coefficient in units of hours⁻²,
R_{P} is the photoperiod sensitivity as a unitless scalar, and
L_{P} is the daylength in units of hours.

DORM accounts for the photoperiod sensitivity and daylength on a crop's rate of development between the phenological stages of emergence and flowering. It can range between 1 (no slowing of development) to 0 (complete pause of development). In certain embodiments, the temperature-derived daily optimum development degree days (DOPT) of a winter crop is multiplied by the daily dormancy function value (DORM) to derive the daily actual development degree days (DACT).

The DACT reflects the slowing of growth of effectively reduced degree days on given day as dictated by a crop's photoperiod sensitivity and daylength at the field location. Less degree days results in the need of more days during the winter months to achieve the same pace of development as a crop not experiencing dormancy. The DACT is defined as follows:

$$DACT = DOPT * DORM , degree days . \qquad Eq . 11$$

In order to calculate the user crop maturity date for a winter crop, the UDDMAT is adjusted in certain embodiments to account for dormancy during a growing season. For spring crops, the UDDMAT is the required accumulated degree days between emergence and maturity dates based on a user DTM and the assumption that the variety's planting date followed historical practices. Without dormancy, the UDDMAT would correspond to the summation of DOPT degree days between user emergence and maturity dates as follows:

$$UDDMAT = \sum DOPT degree days between UEMDATE and UMATDATE , degree days . \qquad Eq . 12$$

With dormancy, the UDDMAT would include two summations in certain embodiments. One summation would be of actual development (DACT) degree days between user emergence and flowering dates and a second summation would be of optimal development (DOCT) degree days between user flowering and maturity dates. The UDDMATD corresponds to the UDDMAT adjusted for dormancy:

$$UDDMATD = \sum DACT degree days between UEMDATE and UFLDATE + \sum DOPT degree days between UFLDATE and UMATDATE , degree days . \qquad Eq . 13$$

With the derivation of UDDMATD, the user crop maturity date (UMATDATE) for a winter crop is computed by adding to the user emergence date (UEMDATE) the UDDMATD in equivalent days for the period defined by the accumulated degree days as follows:

$$UMATDATE = UEMDATE + UDDMATD ( days ) , DOY . \qquad Eq . 14$$

### 3.5 User Crop Maturity Date and Equifinality

The degree days between a user's flowering date and maturity date can be furthered adjusted for equifinality. In certain embodiments, the crop phenology model accounts for equifinality by crediting each day's degree day requirement between flowering and maturity according to the delay in development. In certain embodiments, this credit is achieved in three steps. The first step is the calculation of the remaining degree days (DACC) from the calendar date a crop equals or exceeds a crop growth fraction (CGF) of 1.5 to the climatologically-derived maturity date (MATDATE):

$$DACC = \sum degree days between date of CGF 1.5 and MATDATE , degree days . \qquad Eq . 15$$

The second step is to calculate accumulated degree days (DCLI) between the climatologically-derived date for CGF of 1.5 and maturity date (MATDATE):

$$DCLI = \sum degree days between date of CGF 1.5 and MATDATE , degree days . \qquad Eq . 16$$

In the third step, if DCLI is greater than DACC, then the crop does not have enough predicted degree days to reach maturity due to a significant delay in development at the time of flowering. The ratio of DCLI/DACC is a scalar called the “accelerator” (ACC); its value is constrained to be greater than 1.0. DACC is multiplied by the accelerator ratio to adjust the accumulated degree days (ADACC) between the date of CGF of 1.5 and MATDATE:

$$ADACC = ACC * DACC , degree days . \qquad Eq . 17$$

In certain embodiments, an in-season crop has its daily degree days increased by the accelerator for each day after the date it attains a CGF of 1.5. By crediting the daily degree days, the in-season crop increases or accelerates the accumulation of degrees days until the date of maturity. The speeding up of crop development between a CGF of 1.5 to maturity is termed equifinality.

### 3.6 User Crop Harvest Date

In the case of both spring and winter crops, seed manufacturers rarely published the number of days from maturity to harvest for a specific crop variety (e.g., crop type). The length of the period between maturity and harvest may vary depending on a user's planting date, choice of variety, and prevailing weather conditions during a growing season. Consequently, like the period between planting and emergence, the degree day accumulation for the period between maturity and harvest can be derived climatologically using, for example, ten years of historical average air temperatures. This derivation of degree day accumulation assumes a crop was planted within a range of dates consistent with historical practices at a given location. The climatically-derived accumulated degree days (DDHRV) between the 50% cohort maturity date (MATDATE50%) and 50% cohort harvest date (HRVDATE50%) is as follows:

$$DDHRV = \sum degree days between MATDATES 50 \% and HRVDATE 50 \% , degree days . \qquad Eq . 18$$

The user crop harvest date (UHRVDATE) is calculated by adding the DDHRV in equivalent days for the period defined by the accumulated degree days to the user maturity date (UMATDATE):

$$UHRVDATE = UMATDATE + DDHRV ( days ) , DOY . \qquad Eq . 19$$

In certain embodiments, the daily growth fraction is calculated between the maturity date and the harvest date by calculating the daily degree day accumulation divided by the DDHRV. The accumulation of the growth fraction begins at 2.0 (UMATDATE) and ends at 3.0 (UHRVDATE) and spans the BBCH range of 89 to 99 based on the varietal mapping of the BBCH code to the accumulated growth fraction (AGF).

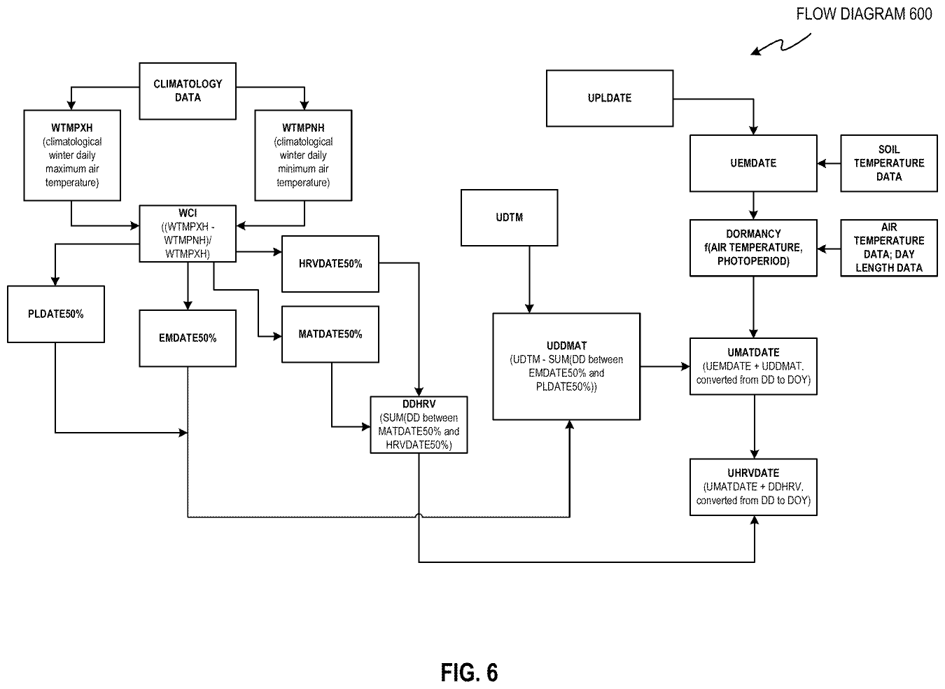

FIG. 6 is a flow diagram 600 illustrating the field-level crop phenology model utilizing the modeling parameters and systems of equations described and defined above to illustrate the various inputs and outputs at each stage of the model.

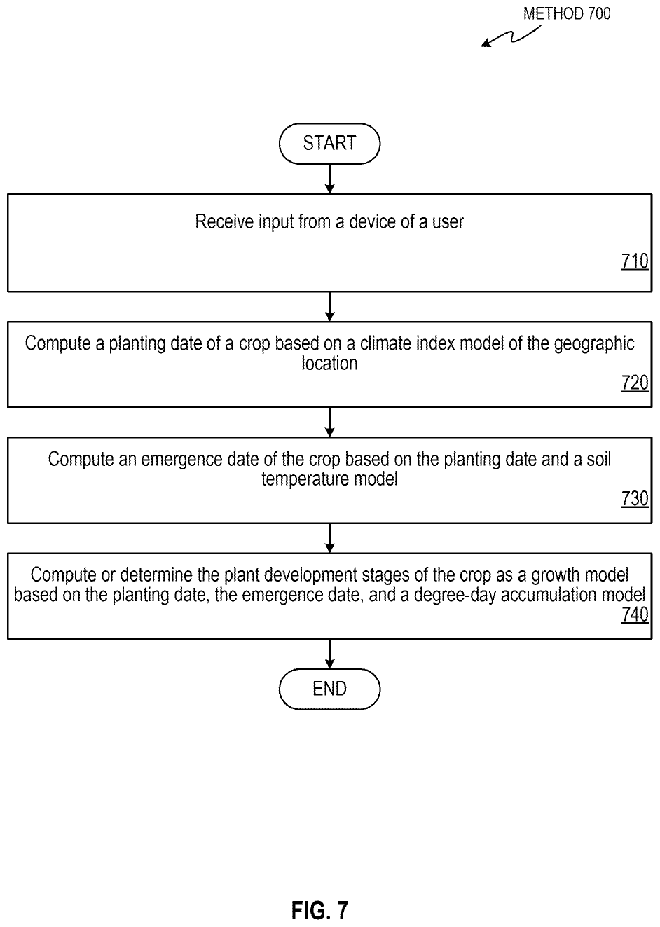

FIG. 7 is a flow diagram illustrating a method 700 for simulating plant development stages in accordance with embodiments of the present disclosure. The method 700 may be performed by processing logic that includes hardware (e.g., circuitry, dedicated logic, programmable logic, microcode, etc.), software (e.g., instructions run on a processing device to perform hardware simulation), or a combination thereof. In certain embodiments, one or more elements of the method 700 may be performed, for example, by a modeling server (e.g., the crop yield modeling component 140 of the modeling server 130).

At block 710, the processing device (e.g., a processing device of the modeling server 130) receives an input (e.g., via the network 105) from a device of a user (e.g., one or more of the user devices 120A-120Z via their respective user interfaces 122A-122Z). In certain embodiments, the input comprises one or more crop varieties (e.g., identifiers of one or more crop types), and a geographic location for crop(s) to be grown.

In certain embodiments, the input does not specify the planting date of the crop. In other embodiments, the user input specifies an actual planting date or a target planting date. In certain embodiments, the geographic location is specified as a geopolitical location, such as a country, state/region, city, or town. In certain embodiments, the geographic location is specified by ranges of latitude and longitude or global positioning system coordinates. In certain embodiments, the location information is obtained directly from the device (e.g., where the device is located at the time of the input) such that the user need not input the location directly.

At block 720, the processing device computes a planting date of the crop based on either the annual climate index (Eq. 1) or the winter climate index (Eq. 2) value at the specified geographic location. In certain embodiments, the climate index model is generated by modeling historical planting dates for the type of the crop as a function of the climate index.

At block 730, the processing device computes an emergence date based on the planting date and a soil temperature model. In certain embodiments, the processing device simulates soil temperature at the seeding depth for the type of the crop. In certain embodiments, the processing device computes the emergence date by estimating, based on the soil temperature model, a number of days from the planting date of the crop to reach a target growth fraction of the crop representing emergence.

At block 740, the processing device determines/computes (e.g., simulates) the plant development stages of the crop as a growth profile based on the planting date, the emergence date, and a degree-day accumulation model. In certain embodiments, the processing device simulates crop phenological development to maturity using a model of degree day accumulations to determine dates on which phenological stages will be reached at specific location and during a specific growing season. The target number of accumulated degree days is determined based on historical crop maturity data (e.g., which may be retrieved from the data store 110). In certain embodiments, the processing device computes a maturity date of the crop based on the predicted number of days and the emergence date. In certain embodiments, the processing device adjusts growing degree days during winter months to reflect photoperiod sensitivity of winter crops.

In certain embodiments, the processing device transmits the growth profile to the device of the user for display. In certain embodiments, the processing device transmits the growth profile to a separate computing device for additional modeling or to generate a recommendation of an agent to apply to the crop. In certain embodiments, the processing device transmits the growth profile to a device adapted to operate a tool for harvesting or treating the crop.

### Crop Yield Modeling

Certain embodiments of the present disclosure relate to a crop yield model that provides a simulation of the end-of-season yield potential for a given growing season based on environmental stresses and management practices that can influence the development of the crop at field-scale. Timing of chemical applications and on-farm management decisions can be aided by when periods of crop stress are known to occur. Knowledge of the timing of stresses and the magnitude of the impact on crop yield can provide a powerful decision-making tool for growers.

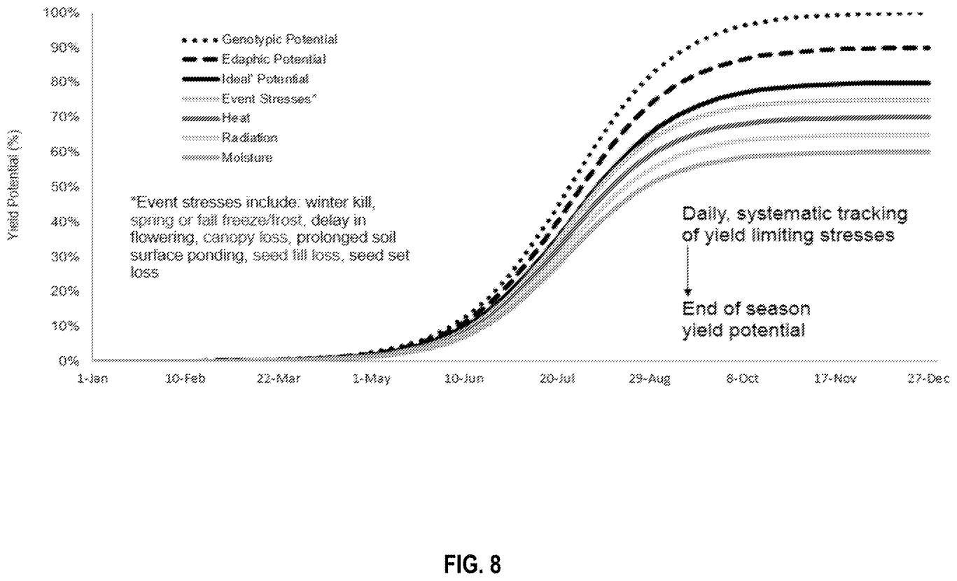

In certain embodiments, the crop yield model begins with a yield potential that is reflective of a user's (e.g. crop grower's) environmental limitations (e.g., taking into consideration their local soil and climate) and assumes that the user chose a crop variety that is appropriate for their growing season and conducted management on their farm in the most optimal way. As environmental stressors occur, the end-of-season yield is decreased depending on the magnitude and timing of the stress events. FIG. 8 is a plot illustrating how yield potential can be calculated by starting with genotypic potential and ending at a predicted yield potential by applying various subtractive penalties. For example, in certain embodiments, the crop yield model begins with the maximum possible yield, and as stresses occur their impact is subtracted from the maximum possible yield. The stresses may include, for example, environmental, developmental, and event stresses. FIG. 8 shows an exemplary order in which the stresses are applied. The stresses may include, for example, environmental, developmental, and event stresses. The model can be run under different scenarios: historic, preseason, and in-season.

### 1. Model Inputs

In certain embodiments, the user inputs for the crop yield model include location, planting date, crop type, varietal days to maturity (DTM), and soil textural classification. Based on the user input provided, other parameters may be identified as model inputs and retrieved to run the simulation, such as those listed in Table 2.

TABLE 2
List of crop and soil inputs for certain
embodiments of the crop yield model

| | Units |
|---|---|
| Crop Inputs | |
| Root zone depth | mm |
| Maximum leaf area index | unitless |
| Evapotranspiration coefficients by growth stage | unitless |
| Excess soil moisture coefficient | unitless |
| Frost/freeze injury temperatures | ° C. |
| Winter survival temperature | ° C. |
| Temperature acclimation coefficients | unitless |
| Soil Inputs | |
| Available water holding capacity | mm³ water/mm³ soil |
| Thermal conductivity | mcal/mm · s · ° C. |
| Volumetric heat capacity | cal/mm · s · ° C. |
| Damping depth | mm |

In certain embodiments, the crop yield model utilizes weather input data, such as the various parameters listed in Table 3. From the user inputs, derived weather variables may be calculated including daylength (based on the user's location and date), maximum clear sky total incoming solar radiation (relative to the user's location), actual clear sky total incoming solar radiation (amount received on any given day based on cloudiness), and open water evaporation. In addition to the direct and derived weather inputs, derived soil temperatures may be calculated as well as the daily accumulated growing degree days.

TABLE 3
Model inputs relating to weather and soil

| | Units |
|---|---|
| Weather Inputs | |
| Maximum air temperature | ° C. |
| Minimum air temperature | ° C. |
| Mean station air temperature | hPa |
| Mean relative humidity | % |
| Mean windspeed | m/s |
| Mean cloud cover | % |
| Total precipitation | mm |
| Total snow depth | mm |
| Derived Weather Inputs | |
| Daylength | hr |
| Maximum total clear sky total incoming solar | mJ/m² |
| radiation | |
| Actual clear sky total incoming solar radiation | mJ/m² |
| Open water evaporation | mm |
| Derived Soil Inputs | |
| Surface soil temperature | ° C. |
| Soil temperature 2.5 cm | ° C. |
| Soil temperature 5 cm | ° C. |
| Derived Crop Inputs | |
| Growing degree days (crop-specific base | unitless |
| temperatures) | |

In certain embodiments, the crop yield model distinguishes between “ideal” and “actual” crop yield scenarios. The “ideal” crop yield corresponds to a maximum potential yield for a given crop type and variety without any limitations to development beyond those associated with the limitations of the user location (e.g., climatology and edaphic properties). Beyond these limitations, the “actual” crop yield results from developmental stresses (e.g., heat, soil moisture, radiation) throughout the growing season in combination with event stresses (e.g., winterkill, frost/freeze events) that impact the development of the crop and the yield potential.

In certain embodiments, crop development accounts for a user-defined or predicted planting date (as discussed above with respect to the phenology model embodiments) and varietal information in the form of days to maturity (DTM). The DTM may be converted to the number of growing degree days required for the crop to reach maturity (DDMAT) based on the climatology of the region. In certain embodiments, the emergence of the crop may be based on soil temperature, and emergence to maturity crop development may be based on the daily accumulation of degree days until the value for maturity is reached. The soil temperature and air temperature for the “actual” crop may be based on the current season observations.

The planting date and derived growing degree days to reach maturity may also be used to model the “ideal” crop. In certain embodiments, “ideal” crop development is based on the accumulated climatological average daily degree days and soil temperatures (e.g., 10-year average), and the crop development is representative of average weather conditions during a growing season and not conditions for a specific year. This allows the “ideal” crop to not be influenced by the fluctuations in weather which can occur during a specific season. The emergence of the “ideal” crop may differ from the “actual” crop because the ideal crop emergence is determined by historical average soil temperatures and the actual crop is determined by single season soil temperatures. In certain embodiments, the “ideal” crop requires the same number of accumulated degree days to progress from emergence to reach maturity as the actual crop as defined by climatological degree days indicated by the DTM value. Differences in dates of phenological stages between emergence and maturity between “ideal” and “actual” crop arise due to differential accumulation of degree days for historical periods versus single season periods.

In addition to monitoring the crop phenology through the growth fraction (CGF) or the value of another growth stage scale mapped to CGF (e.g., BBCH values), the development of the crop may also be monitored using leaf area index (LAI) beginning after emergence, which may be used for both “ideal” and “actual” crops. In certain embodiments, each crop type has a maximum LAI value that has been determined through historical observations. Within the model, the maximum LAI value occurs when the degree day accumulation has reached a defined crop-specific fraction of the total number of accumulated degree days required to reach maturity (DDLAI). Each day the LAI fraction is calculated based on the daily degree day accumulation (i.e., in-season for “actual” crop, 10-year climatology for “ideal” crop) divided by DDLAI.

In certain embodiments, crown temperature is a variable for winter crops that is used to determine the survival of the plant over the winter. As used herein, the crown temperature refers to the temperature of the soil that is adjacent to the growing point of the plant, the interface between the root tissue and stem tissue. In the model, this depth may be assumed to be 2 cm for most annual crops. In certain embodiments, the function to calculate the crown temperature uses snow depth and air temperature as inputs. Crown temperature may be calculated between germination and maturity.

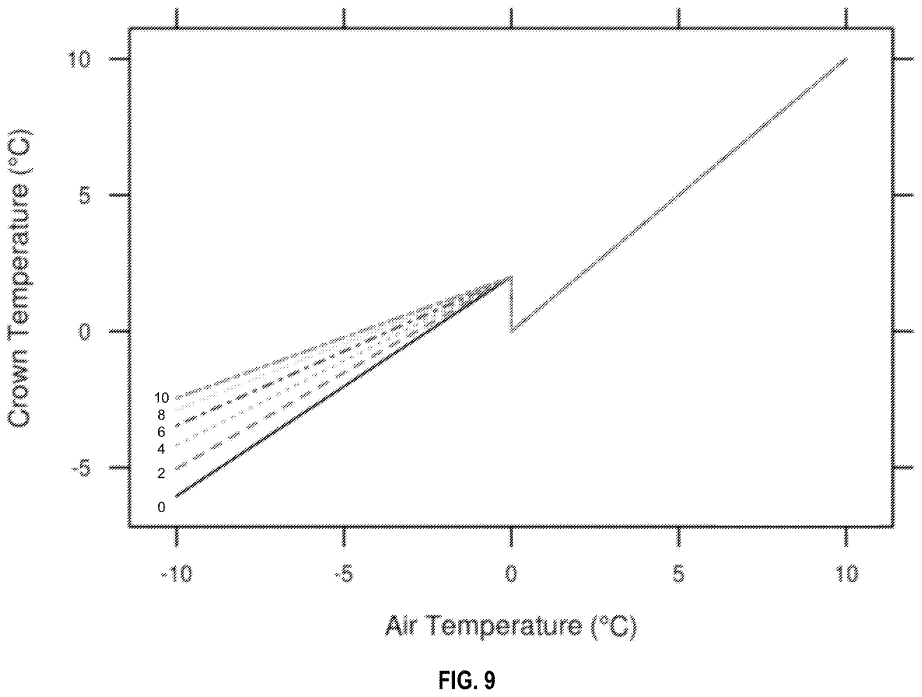

FIG. 9 shows the relationship between air temperature and crown temperature as a function of snow depth (FIG. 2 from Zheng et al., “The APSIM-Wheat Module (7.5 R3008),” 2015, apsim.info). In certain embodiments, the crown temperature function uses the relationship shown in FIG. 9 by calculating the slope of the line representing the snow depth slope (SDS), which relates the air temperature to the crown temperature.

### 2. Environmental Stresses and Varietal Limitations

As discussed above, the “ideal” crop is not subject to any environmental stresses, except for those associated with the user location (e.g., less than ideal soils result in decreased yield potential, location has a shorten growing season due to latitude, etc.). Beginning with the same planting date as the “ideal” crop, the “actual” crop realizes a lower potential yield after accounting for stresses that occur during the growing season. In certain embodiments, the yield of the “actual” crop is less than that of the “ideal” crop.

The “ideal” crop may serve as an important reference for the “actual” crop. First, the “actual” crop development can be paced against “ideal” crop development. That is, by referencing the “ideal” crop, it can be determined if an actual crop is early or late in its development during a growing season. Second, the “ideal” crop provides a daily increment of biomass before any actual crop stresses reduce it.

In certain embodiments, the “actual” crop works on the assumption of fractional yield loss. That is, if there are no stresses, then then the fractional yield loss is 0. If there are accumulated stresses or an extreme stresses, then the fractional yield loss can reach 1.0. Beginning with emergence, there is a day-by-day aboveground maximum growth defined by the ideal crop. If there are any stresses on a given day, the maximum growth will be reduced by some fraction. This reduction is referred to herein as the fractional yield loss. On a day-by-day basis, this loss can range from 0 to 1.0. In certain embodiments, the daily fractional losses are added up throughout a growing season to determine a seasonal fractional yield loss. This seasonal fractional yield loss may be subtracted from 1.0 to calculate the fractional actual yield. The fractional “actual” yield is multiplied by a “delayed planting” potential yield to derive the absolute actual yield. The delayed planting yield is discussed in greater detail below.

In certain embodiments, because the potential at-harvest yield is dependent on the choice of varieties, the absolute actual yield is normalized to a relative historical average yield (e.g., minimum 10 years). The relative yield may be reported to a grower as a fraction that is above 1.0 for a relatively good growing season or below 1.0 for a relatively poor growing season. The relative yield can be multiplied by an historically-determined average yield for a farm to derive a localized, absolute actual yield for a grower.

### 2.1 Genotypic Yield

In certain embodiments, the genotypic yield (GENYLD) is set according to maximum number of degree days associated with theoretical maximum yield value for a selected hybrid. It assumes that all weather, soil, physiological, and management conditions are perfect with no stresses of any kind (i.e., the conditions found in a controlled greenhouse environment). The genotypic yield in both tonnes/hectare and bushels/acre are listed in Table 4 below for selected crops.

TABLE 4
Genotypic yield parameters

| | Gen. Yield | | Gen. Yield |
|---|---|---|---|
| Crop | (tonne/ha) | Conv. To | (bu/acre; *lb/acre) |
| Corn | 25 | 15.932 | 398.25 |
| Cotton* | 8 | 892.87 | 7143.00 |
| Soybean | 10 | 14.87 | 148.70 |
| Sunflower* | 8 | 892.87 | 7143.00 |
| Spring Barley | 10 | 18.587 | 185.87 |
| Spring Canola | 8 | 17.857 | 142.86 |
| Spring Wheat | 10 | 14.87 | 148.70 |
| Spring Barley | 10 | 18.587 | 185.87 |
| Winter Canola | 8 | 17.857 | 142.86 |
| Winter Wheat | 10 | 14.87 | 148.70 |
| Winter Oilseed Rape | 8 | 17.857 | 142.86 |

### 2.2 Edaphic Yield

In certain embodiments, edaphic yield (EDYLD) is an adjustment to the genotypic yield for soils that are less than ideal for crop growth and development. In certain embodiments, only soil texture reduces the genotypic yield. The genotypic yield is multiplied by the edaphic yield fraction to derive the edaphic yield. The edaphic yield fraction is a function of the soil suitability rating for a soil texture. Example edaphic yield fractions are shown in Table 5. The edaphic yield fractions may vary by crop type.

TABLE 5
Edaphic yield fraction as a function of
soil suitability rating and soil texture

| Soil Suitability | Edaphic Yield | |
|---|---|---|
| Rating | Fraction | Soil Texture |
| Very Poor | 0.4116 | heavy clay, medium fine sand, |
| | | sand |
| Poor | 0.5145 | silty clay, loamy fine sand |
| Moderate | 0.6431 | sandy clay loam, silty clay |
| | | loam |
| Good | 0.8039 | silty loam, sandy loam |
| Very Good | 1.0000 | loam |

### 2.3 Phenological Yield

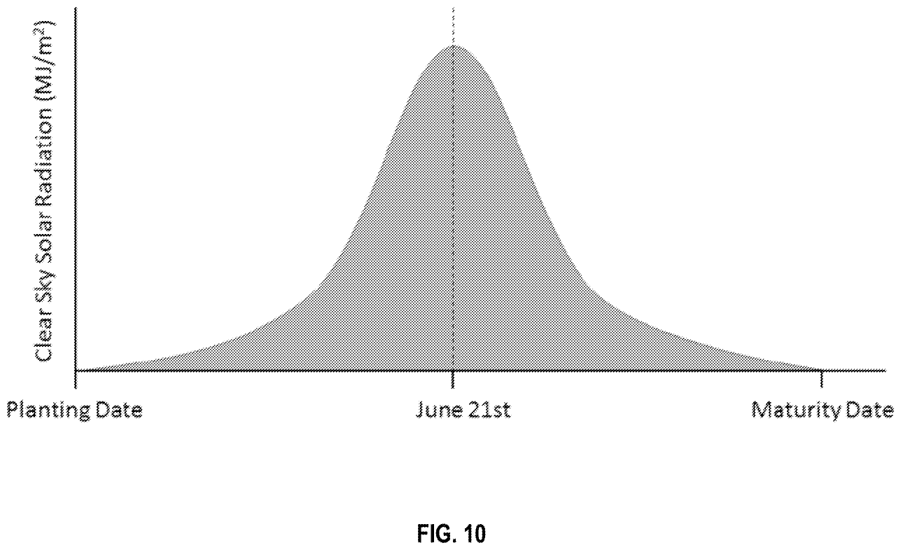

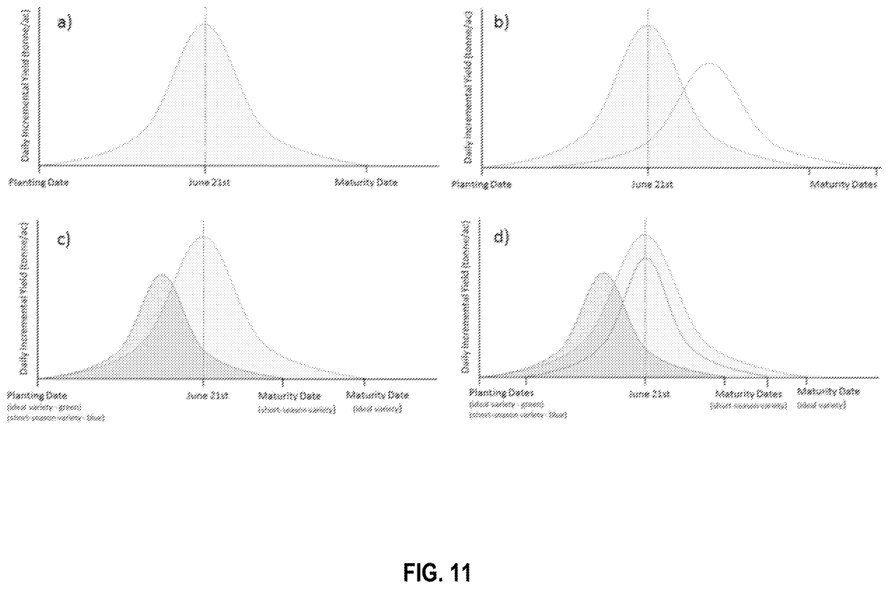

Every location has an ideal planting, emergence, and maturity dates that are based on either the winter climate index (WCI) or the annual climate ratio (RATIO), as described above with respect to the crop phenology model (which is not related to the “ideal” crop described above). The phenological yield (PHENYLD) also assumes that the grower has chosen the optimal variety for their location, one that maximizes the duration of the season and takes full advantage of the available solar radiation for photosynthesis. In certain embodiments, the ideal planting and emergence dates allow this optimal variety to reach inflorescence on June 21st in the northern hemisphere (December 21st in the southern hemisphere). In this context, the model accounts for total accumulation of the maximum clear sky radiation (MCSRC) that can occur between the emergence date and maturity date when centered on the summer solstice. FIG. 10 is a representation of the distribution of the maximum clear sky radiation between the ideal planting and maturity dates, with inflorescence occurring on June 21st. The total amount of accumulated clear sky radiation is a function of the user's latitude and longitude and is represented by the area under this curve. In certain embodiments, the phenological yield (PHENYLD) is the maximum yield possible for a given hybrid and location in any given year, which may be calculated as a function of edaphic yield (EDYLD) and the maximum clear sky radiation (MCSR). A graphical representation of the phenological yield is shown in FIG. 11, where the curve represents the daily incremental yield potential and the area under the curve is the seasonal yield potential. FIG. 11, panel (a), illustrates phenological yield development.

### 2.4 Planting Delay Yield

In certain embodiments, the planting delay yield (PLDYLD) accounts for the fact that most planting dates do not result in the period between emergence and maturity being centered on the longest day (June 21 in the northern hemisphere). The PLDYLD also takes into consideration whether a grower has picked an appropriate variety. FIG. 11, panel (b), demonstrates the impact that a delay in the planting of the ideal variety has on the yield potential, as well as the potential impact for the crop to not reach maturity (curve has shifted right and is decreased in magnitude). A grower has the option of planting a shorter-season variety, in which case, that ideal planting date discussed above may not be appropriate, as illustrated by the left-shifted curve of FIG. 11, panel (c). In this scenario, a delay in the planting of the short-season variety would be beneficial as it is now centered on June 21, and is now capable of maximizing the photosynthetic potential, as illustrated by the curve shifted back to June 21 in FIG. 11, panel (d).

In certain embodiments, PLDYLD is calculated based on the daily simulated clear sky radiation (SIMCSR) between the user planting date and the simulated maturity date (which is dependent on the variety selected):

$$Eq . 20$$

$$SIMCSR = \sum daily MCSR between Planting Date and Maturity Date , MJ / {m}^{2} .$$

While the phenological yield and planting delay yield may both use the same equation for calculating radiation accumulation, they may provide two different results because of differences in radiation accumulation periods. The phenological yield is the theoretically best yield for a location based on the best planting date and choice of variety. The planting delay yield is in almost all cases less than the phenological yield value because the actual planting date is not the optimal date for maximizing radiation for photosynthesis. By comparing the planting delay yield to the phenological yield, the loss in yield can be assessed due to the choice of planting date with everything else being equal (including the variety planted).

At this point, the discussion of the model has accounted for the planting date, variety selection, and geographic limitations of the user's location. These yield limitations predict the “ideal” crop yield. To obtain the, the “actual” crop yield, the “ideal” crop yield is subjected to the stress factors discussed below.

### 3. Development Stresses

In certain embodiments, development stresses are calculated daily and impact yield development on only the current date. In certain embodiments, all development stresses are calculated daily between emergence and maturity and are accumulated over the season for a final season-end yield loss. Equations apply for all crop types unless otherwise stated.

### 3.1 Development Light

After emergence, a crop canopy will receive different levels of incoming solar radiation depending on the amount of cloudiness. How the crop utilizes that radiation is dependent on its growth stage. In certain embodiments, the potential yield on a given day is a function of daily maximum clear sky incoming solar radiation (SRSX) (dependent on the user location) and the leaf area index (LAI) of the canopy. The yield for the “actual” crop is a function of the actual daily incoming solar radiation (SRST) and a threshold determined by the canopy LAI. The calculation of the solar radiation threshold (SRT) for determining the maximum potential yield as a function of the ratio of daily canopy LAI to its maximum value LAI (MAXLAI). The MAXLAI for several crops are listed in Table 6.

TABLE 6
Maximum leaf area index (unitless) by crop type

| Crop | Maximum LAI |
|---|---|
| Corn | 8.0 |
| Cotton | 5.0 |
| India Cotton | 5.0 |
| Soybean | 8.0 |
| Sunflower | 6.0 |
| Spring Canola | 4.5 |
| Spring Wheat | 8.0 |
| Winter Barley | 8.0 |
| Winter Canola | 4.5 |
| Winter oilseed rape | 4.5 |
| Winter Wheat | 8.0 |

In certain embodiments, if the actual daily incoming solar radiation (SRST) is greater than or equal to the threshold, then then a crop, according to the model, will realize the full potential yield development for that day. If SRST is less than the threshold, then the actual yield will be less than its potential value. In certain embodiments, the development light yield loss, as a fraction, is calculated using the solar radiation threshold (SRT) and actual insolation (SRST) according to:

$$Daily Development Light Yield Loss = ( SRT - SRST ) / SRT , \qquad Eq . 21$$

where, SRST<=SRT.

In certain embodiments, the development light yield is determined through the accumulation of the daily development light yield loss:

$$Development Light Yield = 1 - \sum Daily Development Light Yield Loss . \qquad Eq . 22$$

### 3.2 Development Heat

After emergence, a crop may be exposed daily to excessively high temperatures, which can include temperatures that exceed either (or both) the defined minimum (TMN) or maximum (TMX) daily temperature thresholds between crop emergence and maturity, resulting in a loss of yield. This exposure to high temperatures is referred to herein as development heat (Dev Heat) yield loss in the crop model. In certain embodiments, two sets of crop-specific temperature thresholds are defined for both daily minimum (TMN) and daily maximum temperatures (TMX). One threshold in each set defines the temperature at which development heat stress begins and the other threshold defines when maximum development heat stress occurs. If daily TMN and TMX are below the thresholds for the beginning of development heat stress, no development heat stress is indicated. If daily TMN or TMX temperatures exceed the thresholds for maximum development heat stress, the maximum level of development heat stress is applied. If TMN and TMX fall between the thresholds for beginning and maximum heat stress, the daily development heat stress is calculated as a function of the TMN or TMX between the range of temperatures defined by the beginning and maximum temperature thresholds. If crop-specific temperature thresholds are exceeded (implemented as conditional statements for each crop), then defined development heat (Dev Heat) yield is used. Outside of the defined temperature ranges, the crop-specific development heat yield loss can be calculated as a function of minimum (TMNF) and maximum (TMXF) temperature fraction equations defined for each crop.

### 3.3 Development Soil Moisture

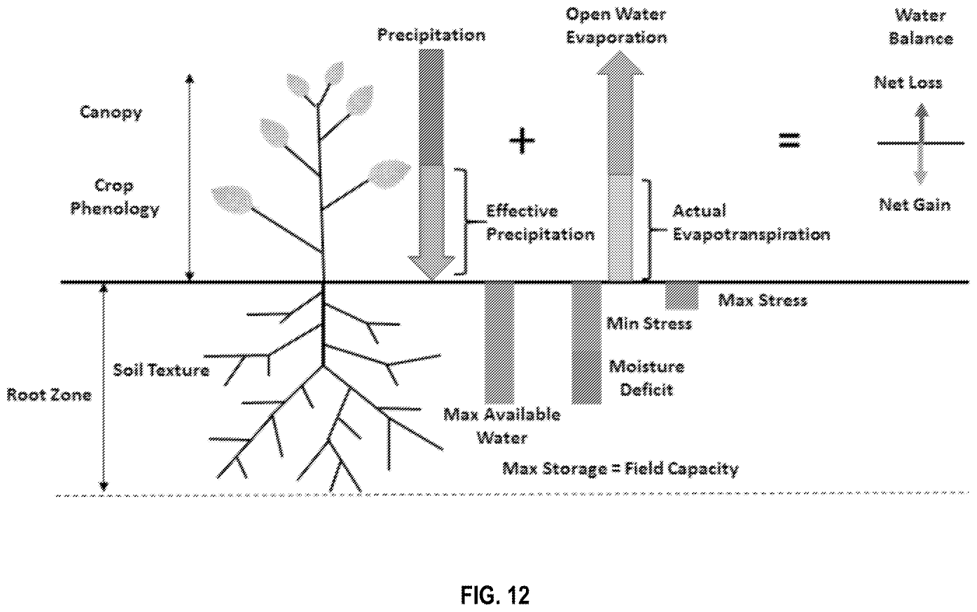

After emergence, crop roots will experience different levels of soil moisture ranging from permanent wilting point to field capacity. In certain embodiments, the maximum available water for a given rooting depth (which increases as the crop develops) on a given day is considered to be the potential soil moisture. The actual available water, calculated from a daily soil water balance (illustrated in FIG. 12), is equal to or less than the maximum value. The daily soil water balance accounts for the availability of water to the roots due to the effective precipitation and the loss of water due to actual crop evapotranspiration. A detailed description of how the effective precipitation and evapotranspiration are calculated is described below.

In certain embodiments, the potential yield on a given day is a function of the potential soil moisture, while the actual yield is a function of the actual soil moisture. The yield loss due to a soil moisture deficit (where actual soil moisture is less than or equal to the potential value) may be calculated according to Eq. 23. The equations to determine if there is a soil moisture deficit are presented below (referred to as the “water budget approach”), outlining the processes illustrated in FIG. 12. The equations are divided into two sections: those that are presented above the soil surface line of the diagram and those represented below the soil surface line.

$$Daily Development Soil Moisture Yield Loss = 1 - Actual available water / Potential available water . \qquad Eq . 23$$

In certain embodiments, the daily increment of development soil moisture yield as a fraction is calculated from the loss fraction as follows:

$$Development Soil Moisture Yield = 1 - \sum Daily Development Soil Moisture Loss . \qquad Eq . 24$$

In certain embodiments, the water budget approach adds precipitation to a soil and subtracts evaporation and crop transpiration to compute the daily available soil moisture. The combined soil evaporation and crop transpiration are commonly referred to as “evapotranspiration.”

In certain embodiments, the budgeted available soil moisture is determined from soil texture and a crop-specific root zone depth, and it fluctuates between an upper value (field capacity) and a lower value (maximum deficit). There is also an intermediate value marking the beginning of crop stress prior to the value marking maximum deficit. When the available moisture drops to or below the lower value (maximum deficit), a crop will suffer irreparable damage (FIG. 12).

### 3.3.1 Above-Ground Calculations

### Effective Precipitation

While a certain amount of precipitation may reach the surface, only a fraction of that total replenishes the soil available water. This is referred to as the “effective” precipitation. The amount of precipitation reaching a soil surface is a function of the crop canopy density and evaporative rate of the vegetation surface. The precipitation entering the soil after canopy interception and evaporation from leaves is referred to as the “effective” precipitation, which, in certain embodiments, is the difference between the total amount of precipitation and the quantity of that precipitation that is intercepted by the canopy.

### Evapotranspiration

In certain embodiments, the crop coefficient is a scaling factor used to adjust the potential evapotranspiration to reflect the crop development and subsequent changes to evapotranspiration during a growing season. The crop coefficient assumes that both the soil and crop have evaporation rates that can be scaled to open water evaporation (discussed below). That is, if either a layer of soil or a crop canopy transports water to the atmosphere at a rate equal to open water surface, then the crop coefficient is set to 1.0. The available water in the soil coupled with a crop canopy architecture can realize a crop coefficient between 0 to greater than 1.0.

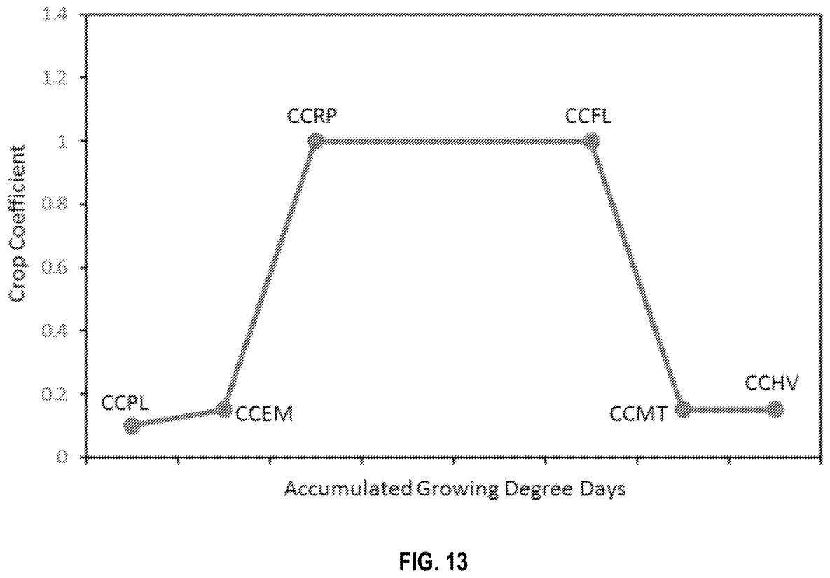

The crop coefficient curve mimics the biomass accumulation of a crop as shown in FIG. 13. In certain embodiments, six coefficients are used to define the curve. The first is the planting crop coefficient (CCPL), which is equivalent to fallow soil at the time of seeding. The second is the emergence crop coefficient (CCEM) corresponding to the start of the vegetative period. The third is the reproductive crop coefficient (CCRP) marking the end of the vegetative period and maximum leaf area index and the start of the reproductive period. The fourth is the flowering crop coefficient (CCFL) which marks the end of the reproductive period and the beginning of fruit development. The fifth is the maturity crop coefficient (CCMT) corresponding to the end of fruit development or maturity. The sixth and last crop coefficient is harvest (CCHV) which marks the end of the growing season but the presence of dying plant material on the soil surface. Note that the values associated with the crop coefficients are crop-dependent and those depicted in FIG. 13 are for illustrative purposes only.

In certain embodiments, each day the crop coefficient (CC) is calculated based on the curve shown in FIG. 13. For example, if the crop development is between emergence and reproduction, the daily crop coefficient value is interpolated between those values using the daily accumulation of degree days divided by the total number of degree days between emergence and reproduction.

In certain embodiments, the evaporation-related processes follow the Food and Agriculture (FAO) scheme, which uses a series of steps and coefficients to calculate both soil evaporation and crop evapotranspiration. First, open water evaporation (EOWT) is provided as a derived variable from the weather data inputs. The EOWT is multiplied by a fixed coefficient of, for example, 0.8 to derive a reference crop evapotranspiration (EVRT) as follows (which in this case is a short grass, the standard vegetation cover at meteorological weather stations):

$$EVRT = 0.8 * EOWT , mm . \qquad Eq . 25$$

In certain embodiments, to determine the potential evapotranspiration, the EVRT needs to be adjusted for the crop by multiplying the EVRT by the daily crop coefficient (CC). This allows for the adjustment of the reference evapotranspiration based on the crop development (lower in the early growth phases to the highest possible rate during the period between reproduction and maturity).

$$E V P T = C C * E V R T , mm . \qquad Eq . 26$$

In certain embodiments, the actual evapotranspiration (EVAT) is derived by first calculating a ratio (EVAT2EVPT) that scales actual evapotranspiration to be less than or equal to a maximum possible daily evapotranspiration limit and then multiplying the that ratio by the potential evapotranspiration (EVPT) as follows:

$$E V A T = E V P T * ( E V A T 2 E V P T ) , mm , \qquad Eq . 27$$

where the EVAT2EVPT ratio is modeled based on available soil moisture after precipitation-related processes and maximum available water above field capacity.

### 3.3.2 Below Ground Calculations

In certain embodiments, soil water budget variables are presented as absolute or relative values. In the case of absolute values, the decreasing or increasing available water, in mm, can be tracked relative to minimum and maximum stress values. This fluctuation in the available soil moisture can be translated into daily and accumulated soil moisture deficits.

In certain embodiments, the soil moisture calculations in the crop yield model are for a single soil layer that runs from the surface to the rooting depth at any date within the growing season. This approach is commonly referred to as the “water bucket.” This reference emphasizes that all the water in a root zone is immediately available to a crop regardless of the depth from the surface.

In certain embodiments, the phenology model is used to adjust the root zone throughout the season according to the stage of crop. Beginning with planting, the root zone steadily increases from a seeding depth to a maximum value, which is defined for each crop type. The root zone determines the maximum soil moisture available to a crop.

In certain embodiments, prior to the planting of a crop, the model assumes a bare soil capable of storing a predetermined amount of water, based on the soil texture, that can be lost to soil evaporation. This predetermined amount of water is calculated as a fraction of maximum water that can stored in a root zone based on the water holding capacity of soil. For example, if the water holding capacity of a soil is 0.18 mm of water per 1 mm soil depth, then a soil of 100 mm will have 18 mm of water available for soil evaporation. The amount of water stored in a specific soil varies by texture and other physical properties.

After planting, the soil moisture available to a crop on day one is the seeding depth which typically ranges between 25.4 and 50.8 mm (1 and 2 inches, respectively). For example, assuming a 0.18 water holding capacity, a 25.4 mm soil depth has a 4.572 mm of available water (25.4 mm soil×0.18 mm water/1 mm soil). As roots grow, the available soil moisture increases accordingly. As a season progresses, the available soil moisture reaches a crop-specific, maximum value defined by the maximum rooting depth (root zone). For example, the maximum rooting depth for wheat is 508 mm. Assuming a water holding capacity of 0.18 mm water per 1 mm soil, the maximum available water in the root zone is 91.44 mm (508 mm soil×0.18 mm water/1 mm soil).

In certain embodiments, at each point in the growing season, the amount of available water at field capacity (AWFC) is calculated based on the soil texture (available water holding capacity or AWHC) and the rooting depth (CRD).

$$A W F C = A W H C * CRD , mm . \qquad Eq . 28$$

In certain embodiments, the actual available soil moisture is determined by precipitation and evaporation-related processes that occur simultaneously in the environment. In the yield model, these processes are iteratively accounted for in an additive fashion. Accordingly, the daily cycle of computing the available soil moisture begins with the previous day's final total moisture as follows:

$$AWT {1}_{t} = AWT {3}_{t - 1} , mm . \qquad Eq . 29$$

Next, the effective precipitation is added to the available soil moisture as follows:

$$AWT {2}_{t} = AWT {1}_{t} + EPCP , mm . \qquad Eq . 30$$

If the effective precipitation is greater than field capacity, then there will be ponding. Ponding is a short-term event when a residual amount of water is on the soil surface following a precipitation event. Ponding is allowed until a maximum depth of water (PONDMX) occurs on the soil surface. In certain embodiments, this maximum value is 25.4 mm. The maximum amount of water due to ponding (PONDMX) is added to the available water at field capacity (AWFC) to derive a maximum available water above field capacity (AWFCX) as follows:

$$AWFCX = AWFC + PONDMX , mm . \qquad Eq . 31$$

If the available soil moisture (AWT2ₜ) is greater than the maximum available water above field capacity (AWFCX), then the amount of possible ponding has been exceeded and the remaining water is considered to be runoff:

$$RUNOFF = AWT {2}_{t} - A W F C X , if AWT {2}_{t} > A W F C X , mm . \qquad Eq . 32$$

Otherwise, when AWT2ₜ is less than or equal to AWFCX, it represents the soil moisture budget after precipitation-related processes.

The actual evapotranspiration is subtracted from available soil moisture after accounting for precipitation-related processes as follows:

$$A W T {3}_{t} = A W T {2}_{t} - E V A T , mm . \qquad Eq . 33$$

In certain embodiments, if the available soil moisture (AWT2ₜ) is less than the actual evapotranspiration, then the available moisture AWT3ₜ is set to 0. The daily cycle of calculating the available soil moisture is now complete with the final AWT3ₜ becoming the starting point for the next day's calculation.

In certain embodiments, the ratio of actual to potential evapotranspiration (EVAT/EVPT) is considered to be equivalent to the actual to potential soil moisture that is used to calculate the development stress on yield due to soil moisture.

### 4. Event Stresses

### 4.1 Winterkill

Winter crops and perennials require a prolonged period of cold to withstand cold-related stresses during the winter months or they become susceptible to winterkill. In certain embodiments, the accumulation of “cold hardiness days” is an input into the calculation of the minimal survival temperature, which in turn is an input into the calculation of the winterkill yield loss.

In certain embodiments, cold hardiness days are accumulated when a crop's development reaches a defined, crop-specific early vegetative state, for example, three leaves (BBCH 13) for winter wheat and winter barley. For each day after that specific growth stage, if the crown temperature (discussed previously) on any day is less than or equal to 9° C., that day is counted as a cold hardiness day.

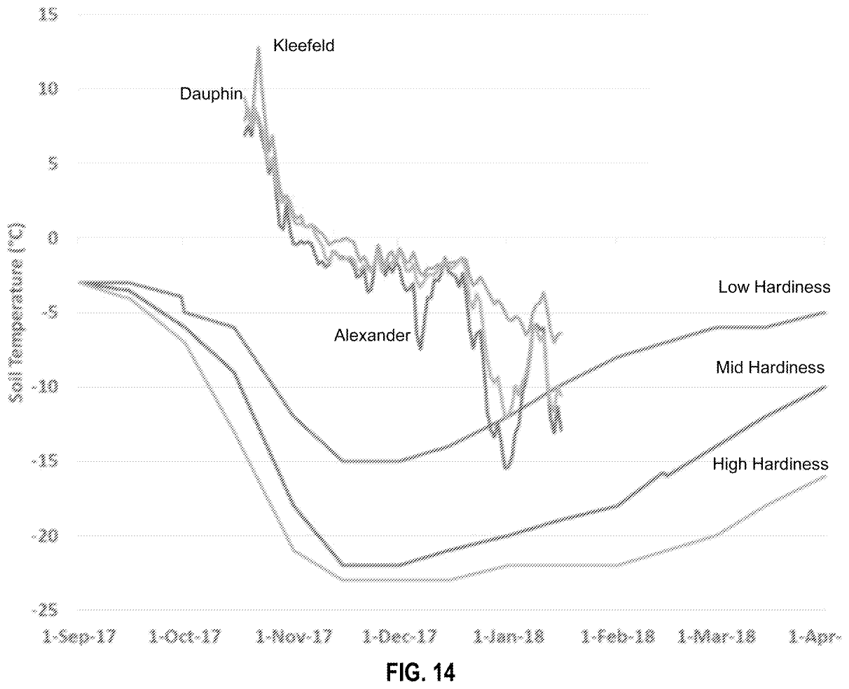

The minimum survival temperature for winter crops is very dynamic from year-to-year. It depends not only on the cold acclimation of a crop, but also snow cover and to some degree soil moisture. FIG. 14 shows minimum survival temperatures for winter wheat varieties that have low, mid, and high hardiness. One-inch (25.4 mm) soil temperatures are overlaid on the minimum survival temperature curves (source: Manitoba Agriculture Ag Weather Program). In certain embodiments, the day of year and cold hardiness days (CHD) serve as input into the simulated minimum survival temperature curve.

Winterkill occurs as the crown temperature drops to or below minimum survival temperature. In certain embodiments, winterkill days (WKD) are counted when the crown temperature is less than or equal to the minimum survival temperature. The accumulated winterkill days determine the level of cold stress during the winter months. Winterkill yield (WYL) can be expressed according to:

$$WYL = 1 - \sum Daily Winterkill Yield Loss , \qquad Eq . 34$$

and may be computed as a function of accumulated WKD, daily crown temperatures (CROWNT), and daily minimum survival temperatures (MST).

### 4.2 Spring or Fall Frost/Freeze

After emergence, whether a winter crop planted in the fall or a crop planted in the spring, the leaves of the crop may be exposed to a frost or freeze event, which may result in yield loss up until the crop reaches maturity. In certain embodiments, when the crop is impacted by a frost/freeze event, yield loss calculation is dependent on the crop type. In certain embodiments, corn and soybean frost/freeze yield loss is calculated taking into consideration the damage to the leaves, which is a function of the surface soil temperature. Surface soil temperature (ST0A) was used in certain embodiments as it provides a better representation for the radiative heat loss that would be experienced by a young seedling. For all other crops, the yield loss may be modeled using the daily minimum air temperature and defined crop-specific temperature thresholds for yield loss. A spring or fall frost/freeze may be considered a yield loss event and is carried through the remaining growing season. The spring or fall frost/freeze is of concern between the crop growth fractions 1.0 and 2.0 (emergence and maturity), with the extent of loss of yield defined by crop-specific functions and thresholds.

### 4.3 Surface Water Loss

After emergence, a crop can experience a heavy rain event that saturates a soil. A saturated soil prevents oxygen from reaching the roots and thus reduces yield. To account for a saturated soil, the soil water balance allows for the retention of surface water. The presence of surface water indicates that soil moisture is greater than the field capacity (AWFC).

Surface water loss occurs when the available water is between the soil field capacity (AWFC) and the maximum defined ponding depth (PONDMX), which has been set at 25.4 mm in certain embodiments. If on a given day between the emergence and reproductive stages, the soil water balance exceeds the aboveground limit, then that day may be marked as a saturated water day. In certain embodiments, if the accumulated saturated water days exceeds 16 days by the first reproductive growth stage, then the daily yield increments between reproduction and maturity are reduced by 75%. This yield loss is carried through the remainder of the growing season until crop maturity, and can be expressed as:

$$Surface Water Loss Yield = 1 - Surface Water loss . \qquad Eq . 35$$

### 4.4 Canopy Loss

If the “actual” (simulated) crop develops faster than the “ideal” (climatological) crop prior to reproduction, then the “actual” crop canopy will not have reached its full biomass potential and therefore has a reduced yield potential. This reduction in yield results from a reduction of clear sky solar radiation due to a shortened period between emergence and the reproductive stage (less photosynthetic capability) relative to that growth stage interval for the “ideal” crop. In certain embodiments, the canopy yield loss is a function of the accumulated clear sky solar radiation flux for the shortened “actual” crop period relative to the accumulated clear sky radiation flux for the “ideal” crop period. In certain embodiments, the accumulated clear sky radiation for the growing period between emergence and reproduction for the “actual” crop may be updated daily as daily weather observations replace forecasted daily weather predictions that may alter growth stage development of the “actual” crop. Canopy yield can be expressed as:

$$Canopy Yield = 1 - \sum Daily Canopy Yield Loss . \qquad Eq . 36$$

### 4.5 Seed Set Loss

If the actual crop experiences extreme heat in combination with soil moisture stress during flowering stages, there will be poor seed set (reduced number of seeds) resulting in a reduction of yield. In certain embodiments, this yield reduction is calculated in two steps. In the first step, a running three-day average of the maximum daily air temperature is calculated for each day between, for example, growth fractions stages 1.45 and 1.55 (just after the onset of flowering until approximately 50% flowering). Each day, the three-day average air temperature is compared to a crop-specific maximum temperature threshold (TMXT), which marks the start of heat stress.

In the second step, the seed set yield loss for the remainder of the season can be calculated as a function of a maximum temperature fraction (TMXF) and the three-day average available soil moisture during that period (AW3DA). The maximum temperature fraction is a stress index that scales air temperatures above TMXT to a range of 0 to 1 using a crop-specific divisor defining the degree of heat stress per degree for temperatures above the threshold.

In certain embodiments, the daily increment of seed set yield is calculated and accumulated over the crop growth fraction period of 1.45 to 1.55 (early stages of flowering to 50% flowering) and is used to calculate the Seed Set Yield for the season:

$$Seed Set Yield = 1 - \sum Daily Seed Set Yield Loss . \qquad Eq . 37$$

### 4.6 Seed Fill Loss

If the actual crop develops more slowly than the ideal crop, there is less time for the translocation of carbohydrates to fill seeds. While there could be sufficient seed set (number of seeds), the average size of all seeds is less than their potential. In certain embodiments, the assessment of seed fill loss is triggered when the ideal crop reaches the reproductive stage (e.g., growth fraction=1.5). The “actual” crop development is compared to the “ideal” crop development on the date when the “ideal” crop reaches growth fraction 1.5. If on that date, the growth fraction of the “actual” crop is less than that of the “ideal” crop, then there will be seed fill loss.

In certain embodiments, the seed fill loss is determined in two steps. First, on the date that the “ideal” crop growth fraction is 1.5 (early flowering) and is ahead of the “actual” crop growth fraction, the seed fill loss ratio (SFLR) of the accumulated “actual” crop yield fraction (Σ actual crop yield) to the accumulated “ideal” crop yield fraction (Σ ideal crop yield) is calculated as follows:

$$S F L R = \sum actual crop yield / \sum ideal crop yield , \qquad Eq . 38$$

where the yield accumulation periods are between emergence and early flowering (growth fraction=1.5) for the ideal crop; and, for the “actual” crop, date of emergence to the date when the “ideal” crop reaches early flowering. If the growth fraction of the “actual” crop is higher than that of the “ideal” crop, SFLR is set to 1.0.

In certain embodiments, the seed fill yield loss is simply the difference between 1.0 and the seed fill loss ratio (SFLR) as follows:

$$Seed Fill Yield Loss = 1. - S F L R . \qquad Eq . 39$$

The daily fractional increment of seed fill yield as a fraction is calculated from the loss fraction as follows:

$$Seed Fill Yield = 1 - Seed Fill Yield Loss = S F L R . \qquad Eq . 40$$

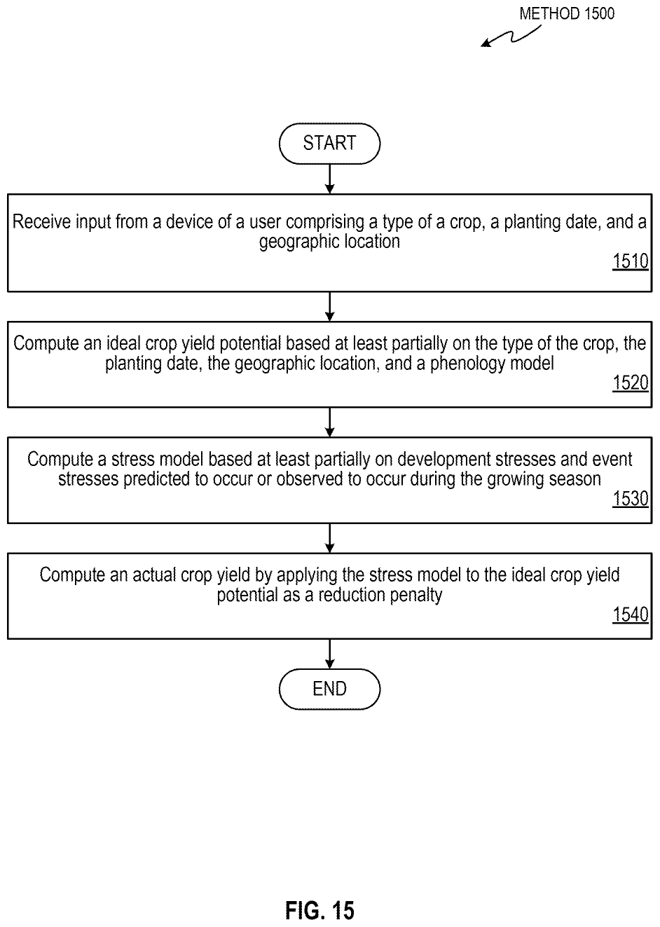

FIG. 15 is a flow diagram illustrating a method 1500 for determining/computing (e.g., simulating) crop yield for a growing season in accordance with embodiments of the present disclosure. The method 1500 may be performed by processing logic that includes hardware (e.g., circuitry, dedicated logic, programmable logic, microcode, etc.), software (e.g., instructions run on a processing device to perform hardware simulation), or a combination thereof. In certain embodiments, one or more elements of the method 1500 may be performed, for example, by a modeling server (e.g., the crop yield modeling component 140 of the modeling server 130).

At block 1510, the processing device (e.g., a processing device of the modeling server 130) receives an input (e.g., via the network 105) from a device of a user (e.g., one or more of the user devices 120A-120Z via their respective user interfaces 122A-122Z). In certain embodiments, the input comprises a type of a crop (e.g., identifiers of one or more crop types), a planting date of the crop, and a geographic location for crop(s) to be grown.

In certain embodiments, the processing device computes or retrieves a plurality of parameters utilized to compute the ideal crop yield potential. In certain embodiments, the plurality of parameters are representative of weather conditions, soil properties, and crop specific growing degree days required for crop maturity, and wherein the plurality of parameters are derived based at least partially from the type of a crop, a planting date of the crop, and a geographic location in combination with historical weather and crop observations.

In certain embodiments, the input does not specify the planting date of the crop. In other embodiments, the user input specifies an actual planting date or a target planting date. In certain embodiments, the geographic location is specified as a geopolitical location, such as a country, state/region, city, or town. In certain embodiments, the geographic location is specified by ranges of latitude and longitude or global positioning system coordinates. In certain embodiments, the location information is obtained directly from the device (e.g., where the device is located at the time of the input) such that the user need not input the location directly.

At block 1520, the processing device computes an ideal crop yield potential based at least partially on the type of the crop, the planting date, the geographic location, and a phenology model. In certain embodiments, the ideal crop potential is computed as a profile representative of crop yield potential as a function of date that is representative of maximum potential yield computed with respect to the geographic location and without developmental stresses, environmental stresses, and event stresses. In certain embodiments, the processing device computes the phenology model by simulating plant development stages of the crop based on the planting date, an estimated emergence date, and a degree-day accumulation model. The phenology model may be computed, for example, in accordance with the method 700.

At block 1530, the processing device computes a stress model based at least partially on development stresses and event stresses predicted to occur or observed to occur during the growing season. In certain embodiments, the processing device computes development stresses based at least partially on radiation loss, extreme temperatures, and moisture loss conditions predicted during the growing season. In certain embodiments, the processing device computes event stresses based at least partially on seed set loss and seed fill loss models. In certain embodiments, the processing device computes event stresses based at least partially on soil moisture model and canopy development loss models.

At block 1540, the processing device computes an actual crop yield by applying the stress model to the ideal crop yield potential as a reduction penalty.

In certain embodiments, the processing device transmits the actual crop yield to the device of the user for display. In certain embodiments, the processing device transmits the growth profile to a separate computing device for additional modeling or to generate a recommendation of an agent to apply to the crop. In certain embodiments, the processing device transmits the growth profile to a device adapted to operate a tool for harvesting or treating the crop.

It is to be understood that the embodiments described herein are not limited to use in any one particular application or environment and that changes may be made to the disclosed implementations without departing from the spirit and scope of the disclosure. Although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring instructions for performing such methods to computing devices. The term “article of manufacture,” as used herein, is intended to encompass a computer program accessible from any computer-readable device or storage media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “configuring,” “receiving,” “converting,” “causing,” “streaming,” “applying,” “masking,” “displaying,” “retrieving,” “transmitting,” “computing,” “generating,” “adding,” “subtracting,” “multiplying,” “dividing,” “selecting,” “parsing,” “optimizing,” “calibrating,” “detecting,” “storing,” “performing,” “analyzing,” “determining,” “enabling,” “identifying,” “modifying,” “transforming,” “aggregating,” “extracting,” “running,” “scheduling,” “simulating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus, device, or system for performing the operations herein. This apparatus, device, or system may be specially constructed for the required purposes, or it may include a general purpose computer selectively activated or reconfigured by a computer program stored in the computer. Such a computer program may be stored in a computer- or machine-readable storage medium, such as, but not limited to, any type of disk including floppy disks, optical disks, compact disk read-only memories (CD-ROMs), and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment” or “one embodiment” means that a particular feature, structure, or characteristic described in connection with the embodiment is included in at least one embodiment. Thus, the appearances of the phrase “an embodiment” or “one embodiment” in various places throughout this specification are not necessarily all referring to the same embodiment. Moreover, it is noted that the “A-Z” notation used in reference to certain elements of the drawings is not intended to be limiting to a particular number of elements. Thus, “A-Z” is to be construed as having one or more of the element present in a particular embodiment.

The present disclosure is not to be limited in scope by the specific embodiments described herein. Indeed, other various embodiments of and modifications to the present disclosure, in addition to those described herein, will be apparent to those of ordinary skill in the art from the description and accompanying drawings. Thus, such other embodiments and modifications are intended to fall within the scope of the present disclosure. Further, while the present disclosure has been described in the context of a particular embodiment in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

The present invention can also be described by the below Embodiments:

Embodiment 1: A method of determining, computing or simulating a crop yield for a growing season, the method comprising:
receiving an input from a device of a user, from a database, or from a sensor, the input comprising a type of a crop, a planting date of the crop, and a geographic location for the crop to be grown;
computing an ideal crop yield potential based at least partially on the type of the crop, the planting date, the geographic location, and a phenology model;
computing a stress model based at least partially on development stresses and event stresses predicted to occur or observed to occur during the growing season;
computing an actual crop yield by applying the stress model to the ideal crop yield potential as a reduction penalty; and
transmitting the actual crop yield to one or more of:
   a device of the user for display;
   a separate computing device for additional modeling or to generate a recommendation of an agent to apply to the crop; or
   a device adapted to operate a tool for harvesting or treating the crop.
      Embodiment 2: The method of Embodiment 1, further comprising:
computing or retrieving a plurality of parameters utilized to compute the ideal crop yield potential, wherein the plurality of parameters are representative of weather conditions, soil properties, and crop specific growing degree days required for crop maturity, and wherein the plurality of parameters are derived at least partially from the type of a crop, a planting date of the crop, and a geographic location in combination with historical weather and crop observations.
   Embodiment 3: The method of any of Embodiments 1-2, wherein the ideal crop potential is computed as a profile representative of crop yield potential as a function of date that is representative of maximum potential yield computed with respect to the geographic location and without developmental stresses, environmental stresses, and event stresses.
   Embodiment 4: The method of any of Embodiments 1-3, further comprising:
computing the phenology model by determining, computing or simulating plant development stages of the crop based on the planting date, crop variety, an estimated emergence date, and a degree-day accumulation model.
   Embodiment 5: The method of any of Embodiments 1-4, further comprising:
computing development stresses based at least partially on radiation loss, extreme temperatures, and moisture loss conditions predicted during the growing season.
   Embodiment 6: The method of any of Embodiments 1-5, further comprising:
computing event stresses based at least partially on seed set loss and seed fill loss models.
   Embodiment 7: The method of any of Embodiments 1-6, further comprising:
computing event stresses based at least partially on soil moisture model and canopy development loss models.
   Embodiment 8: The method of any of Embodiments 1-7, further comprising: using the actual crop yield at least partially as direct or indirect control parameter to control an agricultural machinery usable for treating the crop.
   Embodiment 9: The method of any of Embodiments 1-8, further comprising: causing device to operate the tool for harvesting or treating the crop based on the computed actual crop yield.
   Embodiment 10: A system for determining, computing or simulating crop yield for a growing season, the system comprising: a memory device; and a processing device operatively coupled to the memory device, wherein the processing device is configured to perform the method of any of Embodiments 1-9.
   Embodiment 11: A non-transitory computer-readable medium having instructions encoded thereon that, when executed by a processing device, cause the processing device to perform the method of any of Embodiments 1-9.
   Embodiment 12: A tool for harvesting or treating a crop comprising an on-board processing device configured to perform the method of any of Embodiments 1-9.

1. A method comprising:
receiving an input comprising a type of a crop, a planting date of the crop, and a geographic location for the crop to be grown;
computing an ideal crop yield potential based at least partially on the type of the crop, the planting date, the geographic location, and a phenology model;
computing a stress model based at least partially on one or more development stresses and one or more event stresses predicted to occur or observed to occur during a growing season;
computing an actual crop yield by applying the stress model to the ideal crop yield potential as a reduction penalty; and
transmitting the actual crop yield to one or more of:
a first device of a user;
a computing device adapted to perform one or more of: executing additional modeling generating a recommendation of an agent to apply to the crop; or
a second device adapted to operate a tool for one or more of harvesting the crop or treating the crop.

2. The method of claim 1, further comprising:
identifying a plurality of parameters utilized to compute the ideal crop yield potential, wherein the plurality of parameters are representative of weather conditions, soil properties, and crop specific growing degree days required for crop maturity, and wherein the plurality of parameters are derived at least partially from the type of a crop, a planting date of the crop, and a geographic location in combination with historical weather and crop observations.

3. The method of claim 1, wherein the ideal crop potential is computed as a profile representative of crop yield potential as a function of a date that is representative of a maximum potential yield computed with respect to the geographic location and without developmental stresses, environmental stresses, and event stresses.

4. The method of claim 1, further comprising:
computing the phenology model by one of determining, computing, or simulating plant development stages of the crop based on the planting date, crop variety, an estimated emergence date, and a degree-day accumulation model.

5. The method of claim 1, further comprising:
computing the one or more development stresses based at least partially on radiation loss, extreme temperatures, and moisture loss conditions predicted during the growing season.

6. The method of claim 1, further comprising:
computing the one or more event stresses based at least partially on seed set loss and seed fill loss models.

7. The method of claim 1, further comprising:
computing the one or more event stresses based at least partially on soil moisture model and canopy development loss models.

8. The method of claim 1, further comprising:
using the actual crop yield at least partially as one or more of a direct control parameter or an indirect control parameter to control an agricultural machinery usable to treat the crop.

9. The method of claim 1, further comprising:
causing a tool to harvest or treat the crop based on the actual crop yield.

10. A system comprising:
a memory device to store instructions; and
a processing device operatively coupled to the memory device, wherein the processing device is configured to execute the instructions perform operations comprising:
receiving an input from a device of a user, from a database, or from a sensor, the input comprising a type of a crop, a planting date of the crop, and a geographic location for the crop to be grown;
computing an ideal crop yield potential based at least partially on the type of the crop, the planting date, the geographic location, and a phenology model;
computing a stress model based at least partially on one or more development stresses and one or more event stresses predicted to occur or observed to occur during a growing season;
computing an actual crop yield by applying the stress model to the ideal crop yield potential as a reduction penalty; and
transmitting the actual crop yield to one or more of:
a first device of a user;
a computing device adapted to perform one or more of: executing additional modeling generating a recommendation of an agent to apply to the crop; or
a second device adapted to operate a tool for one or more of harvesting the crop or treating the crop.

11. The system of claim 10, the operations further comprising:
identifying a plurality of parameters utilized to compute the ideal crop yield potential, wherein the plurality of parameters are representative of weather conditions, soil properties, and crop specific growing degree days required for crop maturity, and wherein the plurality of parameters are derived at least partially from the type of a crop, a planting date of the crop, and a geographic location in combination with historical weather and crop observations.

12. The system of claim 10, wherein the ideal crop potential is computed as a profile representative of crop yield potential as a function of a date that is representative of a maximum potential yield computed with respect to the geographic location and without developmental stresses, environmental stresses, and event stresses.

13. The system of claim 10, the operations further comprising:
computing the phenology model by one of determining, computing, or simulating plant development stages of the crop based on the planting date, crop variety, an estimated emergence date, and a degree-day accumulation model.

14. The system of claim 10, the operations further comprising:
computing the one or more development stresses based at least partially on radiation loss, extreme temperatures, and moisture loss conditions predicted during the growing season.

15. The system of claim 10, the operations further comprising:
computing the one or more event stresses based at least partially on one or more seed set loss and seed fill loss models.

16. The system of claim 10, the operations further comprising:
computing the one or more event stresses based at least partially on soil moisture model and canopy development loss models.

17. The system of claim 10, the operations further comprising:
using the actual crop yield at least partially as a direct control parameter or an indirect control parameter to control an agricultural machinery usable to treat the crop.

18. The system of claim 10, wherein the system is integrated into agricultural machinery.

19. A non-transitory computer-readable medium comprising instructions, which when executed by a processing device, cause the processing device to perform operations comprising:
receiving an input comprising a type of a crop, a planting date of the crop, and a geographic location for the crop to be grown;
computing an ideal crop yield potential based at least partially on the type of the crop, the planting date, the geographic location, and a phenology model;
computing a stress model based at least partially on one or more development stresses and one or more event stresses predicted to occur or observed to occur during a growing season;
computing an actual crop yield by applying the stress model to the ideal crop yield potential as a reduction penalty; and
transmitting the actual crop yield to one or more of:
a first device of a user;
a computing device adapted to perform one or more of: executing additional modeling or generating a recommendation of an agent to apply to the crop; or
a second device adapted to operate a tool for one or more of harvesting the crop or treating the crop.

20. The non-transitory computer-readable medium of claim 19, the operations further comprising:
identifying a plurality of parameters utilized to compute the ideal crop yield potential, wherein the plurality of parameters are representative of weather conditions, soil properties, and crop specific growing degree days required for crop maturity, and wherein the plurality of parameters are derived at least partially from the type of a crop, a planting date of the crop, and a geographic location in combination with historical weather and crop observations.
